(19) United States
(12) Patent Application Publication
(10) Pub. No.: US 2015/0205492 A1
(43) Pub. Date: Jul. 23, 2015

(54) NAVIGATING AUDIO CONTENT AND SELECTING PORTIONS THEREOF USING CIRCULAR DIAL ON USER INTERFACE

(71) Applicant: John B. Nobil, La Jolla, CA (US)

(72) Inventor: John B. Nobil, La Jolla, CA (US)

(21) Appl. No.: 14/158,967

(22) Filed: Jan. 20, 2014

(51) Int. Cl. G06F 3/0484; H04L 29/06

(52) U.S. Cl. CPC G06F 3/04842; H04L 67/42

(57) ABSTRACT

A consumer electronics (CE) device includes a transceiver configured for receiving a network podcast, a processor configured for receiving podcast data from the transceiver, and a display configured for being controlled by the processor. Additionally, the CE device includes a computer readable storage medium bearing instructions which when executed by the processor configure the processor for presenting on the display a podcast user interface (UI) configured with a circular tracking clock for enabling a user of the CE device to access a beginning of any portion of a segment of the podcast easily and quickly to playback the podcast from the beginning of the portion. The tracking clock defines a closed circular periphery against which a user can move a finger to move forward and backward in time through the podcast.

### FIELD OF THE INVENTION

The present application relates generally to systems and method for manipulating audio content using a user interface (UI) presenting a user-manipulable circular dial.

### BACKGROUND OF THE INVENTION

With the increased prevalence of mobile devices such as smart phones and tablet computers comes the desirability to use them in particular contexts, one of which is playback of audio content. However, present principles recognize that no adequate solutions exist for easily selecting portions of audio content presented for playback when seeking to create a separate audio file from the audio content using a single application and/or user interface.

### SUMMARY OF THE INVENTION

Thus, the present application provides systems, apparatuses, and methods for presenting, e.g., a single user interface (UI) on a display device for manipulating a podcast, voice note, or audio book playback to thereby allow better seeking of a particular portion of the content using a “big dial” jog control/tracking clock on the UI to thereby allow a user to clip a portion of the podcast and save and/or archive it. A user can also browse through saved clips, listen to them, rename them, delete them, and share them via e.g. email and/or a social networking service. Indeed, present principles recognize that this may be done easily through a single software application (e.g., a mobile “app”).

Accordingly, in one embodiment a consumer electronics (CE) device includes a transceiver configured for receiving a network podcast, a processor configured for receiving podcast data from the transceiver, and a display configured for being controlled by the processor. Additionally, the CE device includes a computer readable storage medium bearing instructions which when executed by the processor configure the processor for presenting on the display a podcast user interface (UI) configured with a circular tracking clock for enabling a user of the CE device to access a beginning of any portion of a segment of the podcast easily and quickly to playback the podcast from the beginning of the portion. The tracking clock defines a closed circular periphery against which a user can move a finger to move forward and backward in time through the podcast.

In some implementations, the UI may also be configured with a red record button in the middle of the tracking clock that pulses to indicate recording. Also in some implementations, the UI can be configured with a vertical slide on one side of the tracking clock to, e.g., change volume output of the audio content being presented.

In reference to the tracking clock specifically, if desired it may include plural segment lines radially oriented. In addition, at least every Nth segment line can appear more prominently than adjacent segment lines to, e.g., denote positions in the podcast that are easily discernable to a user (e.g., every Nth segment line denotes another 30 seconds of audio content from the previous N−1 segment line). In addition to the Nth segment lines, a current location of play of the podcast may be indicated by a marker line that rotates around the tracking clock as the podcast plays, and indeed this marker line may be displayed even more prominently than the Nth segment lines as described further below. It may be appreciated that also in some implementations, the tracking clock may be a hollow ring with an inner circular edge spaced from and coaxial to an outer circular edge.

In another aspect, a method includes presenting a user interface (UI) on a display of a display device, where the UI includes a circular dial for enabling a user of the display device to manipulate, at least partially by manipulating the dial, at least a portion of audio content presented on the display device. The dial is understood to define a closed circular periphery against which the user can move a finger to move forward and backward within the audio content. The method also includes receiving user input by manipulating the dial to manipulate the portion of audio content.

In yet another aspect, a computer readable storage medium bears instructions which when executed by a processor cause the processor to receive input directed to a user interface (UI), where the UI includes a dial defining a closed circular periphery around which a user can move a finger to move forward and backward within a first audio content when creating at least a second audio content at least partially from a selected portion of the first audio content. The instructions also cause the processor to edit the first audio content based on the user input that is received using the dial to establish the selected portion.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system according to present principles;

FIG. 2 is an exemplary flowchart of logic for creating and sharing portions of audio content in accordance with present principles;

FIG. 3 is an exemplary flowchart of logic to be undertaken by a server for receiving and sharing created portions of audio content in accordance with present principles;

FIGS. 4 and 5 are exemplary tracking clock user interfaces (UIs) for selecting portions of audio content to create a new “clip” of the one or more portions;

FIG. 6 is an exemplary options window UI for adding metadata to a newly created “clip;”

FIG. 7 is an information page UI presenting metadata for a clip created using a tracking clock UI;

FIG. 8 is yet another exemplary tracking clock UI for selecting portions of audio content to create a new “clip” of one or more portions;

FIG. 9 is an exemplary video playback UI;

FIG. 10 is an exemplary an audio content feed UI;

FIG. 11 is an exemplary ten band audio equalizer UI;

FIG. 12 is an exemplary a settings showing various user-configurable settings for playback and recording options of audio content;

FIG. 13 is an exemplary audio content acquisition UI;

FIG. 14 is an an exemplary audio content UI showing types of available audio content;

FIG. 15 is an exemplary UI showing audio content that may be selected for playback and manipulation;

FIGS. 16 and 17 show exemplary UIs to change settings for the download of audio content for playback and manipulation;

FIG. 18 is an exemplary audio content playlist UI;

FIG. 19 is an exemplary UI showing audio content that may be selected for playback and manipulation;

FIGS. 20 and 21 show an exemplary clips page UI showing recorded clips that may be selected for playback and further manipulation;

FIG. 22 is an information page UI presenting metadata for a clip created using a tracking clock UI;

FIG. 23 is another UI sharing many of the characteristics and configurations of the tracking clock UIs of FIGS. 4, 5, and 8;

FIG. 24 is another exemplary UI for manipulating audio content in accordance with present principles; and

FIG. 25 is another audio content feed UI.

### DETAILED DESCRIPTION OF THE PREFERRED EMBODIMENT

Disclosed are methods, apparatus, and systems for computer based user information. A system herein may include server and client components, connected over a network such that data may be exchanged between the client and server components. The client components may include one or more computing devices. These may include personal computers, laptops, tablet computers, and other mobile devices including smart phones. These client devices may operate with a variety of operating environments. For example, some of the client computers may be running Microsoft Windows® operating system. Other client devices may be running one or more derivatives of the Unix operating system, or operating systems produced by Apple® Computer, such as the IOS® operating system, or the Android® operating system, produced by Google®. While examples of client device configurations are provided, these are only examples and are not meant to be limiting. These operating environments may also include one or more browsing programs, such as Microsoft Internet Explorer®, Firefox, Google Chrome®, or one of the other many browser programs known in the art. The browsing programs on the client devices may be used to access web applications hosted by the server components discussed below.

Server components may include one or more computer servers executing instructions that configure the servers to receive and transmit data over the network. For example, in some implementations, the client and server components may be connected over the Internet. In other implementations, the client and server components may be connected over a local intranet, such as an intranet within a school or a school district. In other implementations a virtual private network may be implemented between the client components and the server components. This virtual private network may then also be implemented over the Internet or an intranet.

The data produced by the servers may be received by the client devices discussed above. The client devices may also generate network data that is received by the servers. The server components may also include load balancers, firewalls, caches, and proxies, and other network infrastructure known in the art for implementing a reliable and secure web site infrastructure. One or more server components may form an apparatus that implement methods of providing a secure community to one or more members. The methods may be implemented by software instructions executing on processors included in the server components. These methods may utilize one or more of the user interface examples provided below.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as the AMD® Athlon® II or Phenom® II processor, Intel® i3®/i5®/i7® processors, Intel Xeon® processor, or any implementation of an ARM® processor. In addition, the processor may be any conventional special purpose processor, including OMAP processors, Qualcomm® processors such as Snapdragon®, or a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. The description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be written in any conventional programming language such as C#, C, C++, BASIC, Pascal, or Java, and run under a conventional operating system. C#, C, C++, BASIC, Pascal, Java, and FORTRAN are industry standard programming languages for which many commercial compilers can be used to create executable code. The system may also be written using interpreted languages such as Pert Python or Ruby. These are examples only and not intended to be limiting.

Those of skill will further appreciate that the various illustrative logical blocks, flowcharts, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Even further, it is to be understood that present principles may be implemented by state logic as well as deterministic logic flows. Moreover, the Figures described herein are understood to generally show methods steps in conjunction with the devices, apparatuses, and elements disclosed herein.

Thus, in one or more example embodiments, the functions and methods described may be implemented in hardware, software, or firmware executed on a processor, or any combination thereof. If implemented in software, the functions may be stored on or transmitted over as one or more instructions or code on a, computer-readable medium. Computer-readable media include both computer storage media and communication media including any medium that facilitates transfer of a computer program from one place to another. However, a computer readable storage medium is not a carrier wave, and may be any available media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Also, any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. Accordingly, it is to be understood that the particular steps and sequences of steps described herein are exemplary and should not be read to limit the disclosure or the claims. Therefore, it is to be understood that in some instances, the functions and logic steps described herein may occur out of the exemplary order shown in the Figures.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.) It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting.

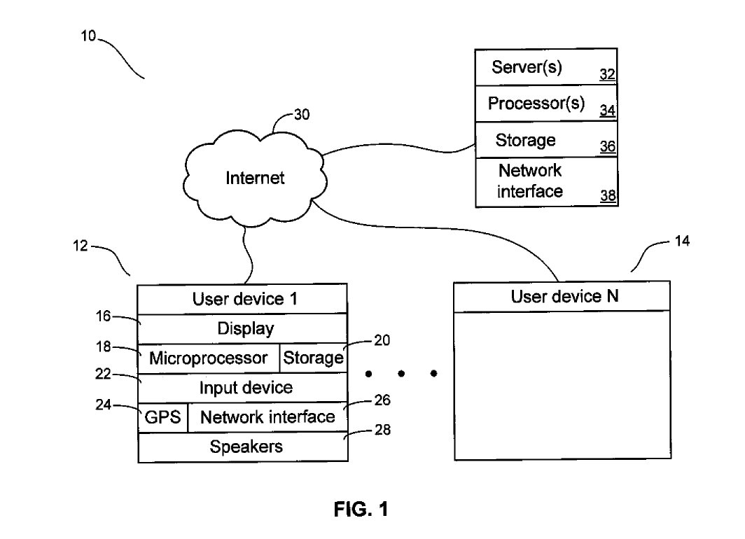

Beginning in reference to FIG. 1, an exemplary system 10 is shown. The system 10 includes a first user device 12 to undertake present principles, at least a second user device 14 if desired that may be similar to the device 12 to be described immediately below to undertake present principles and share clips described with others via e.g. social networking applications, and indeed up to N user devices may be included in the system 10. The user devices 12 and 14 may be, e.g., smart phones, music players, tablet computers, personal digital assistants (PDAs), laptop computers, other small display devices such as portable Internet-enabled TVs, GPS devices, etc. The user device 12 includes at least one touch-enabled display 16 and at least one processor 18. The device 12 also includes at least one tangible computer readable storage medium 20 such as disk-based or solid state storage.

Furthermore, the device 12 includes at least one input device 22 such as, e.g., a touch-sensitive display, a track pad, a key pad, an audio receiver for receiving audible commands and audible input (e.g., such voice notes created and saved using e.g. a voice note application as described further below) which may then be processed and executed by the processor 18, etc. Even further, the device 12 includes a global positioning satellite (GPS) receiver 24 configured to receive geographic position information from at least one satellite and provide the information to the processor 18, though it is to be understood that another suitable position receiver other than a GPS receiver may be used in accordance with present principles. GPS position information may be included in the metadata for the audio content and files created from, e.g., podcasts as described further below.

Also shown on the device 12 is a network interface 26 for communication over at least one network 30 such as the Internet, a WAN, an LAN, etc. under control of the processor 18. The network interface 26 may be, e.g., a wired or wireless modem or router, or other appropriate interface such as, e.g., a wireless telephony transceiver. Note that the device 12 is also shown as including one or more speakers 28. The speakers 28 may output audio such as the podcasts and other audio content described herein.

Still in reference to FIG. 1, a server 32 is also shown. The server 32 at least includes at least one processor 34, at least one tangible computer readable storage medium 36 such as disk-based or solid state storage, and at least one network interface 38 that, under control of the processor 34, allows for communication at least with the devices 12 and 14 over the network 30. Note that the network interface 38 may be, e.g., a wired or wireless modem or router, or other appropriate interface such as, e.g., a wireless telephony transceiver. Accordingly, in some embodiments the server 32 may be an Internet server.

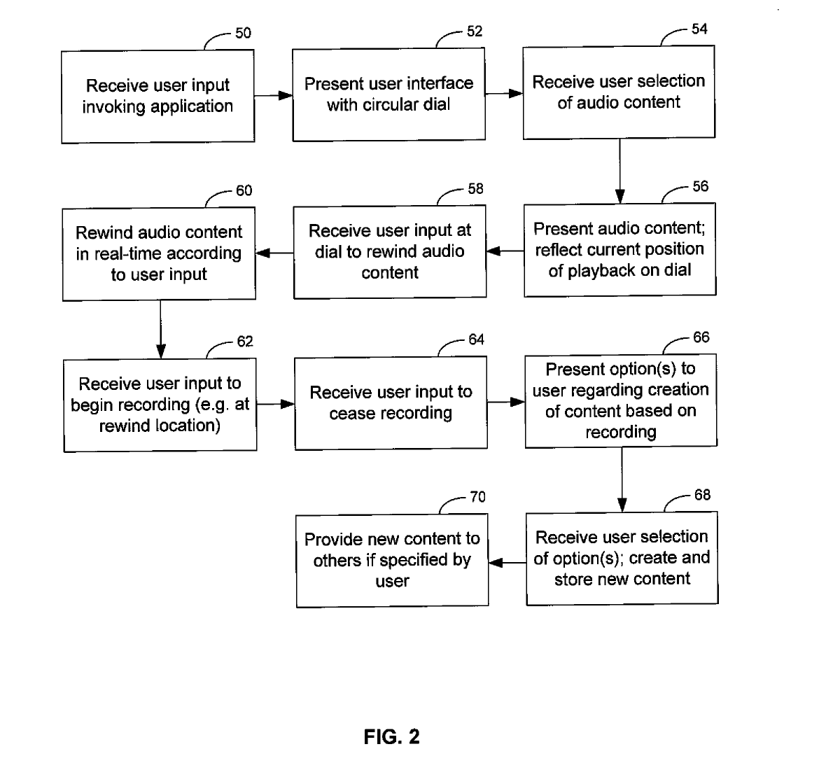

Before moving on to the logic of FIG. 2, note that the processors 18 and 34 are capable of executing all or part of the logic discussed below to undertake present principles, although it is to be generally understood that the processor 18 executes the logic discussed below that is to be executed on the user's end (e.g., on the device 12), and that the processor 34 undertakes the functions below generally executed on the server end (e.g., by the server 32).

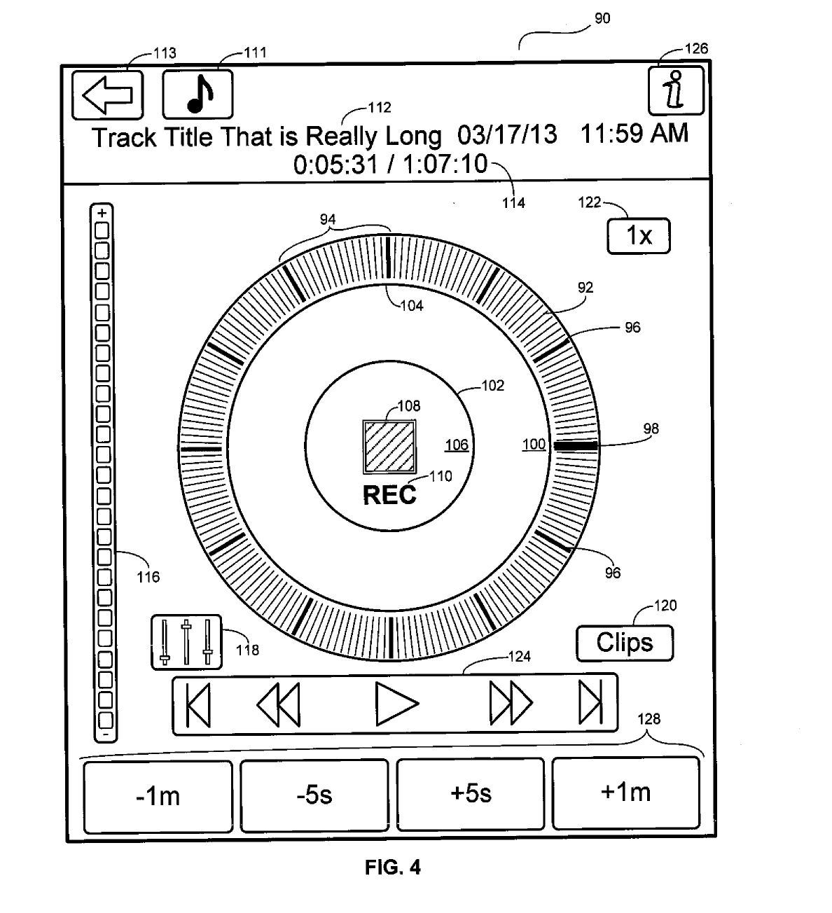

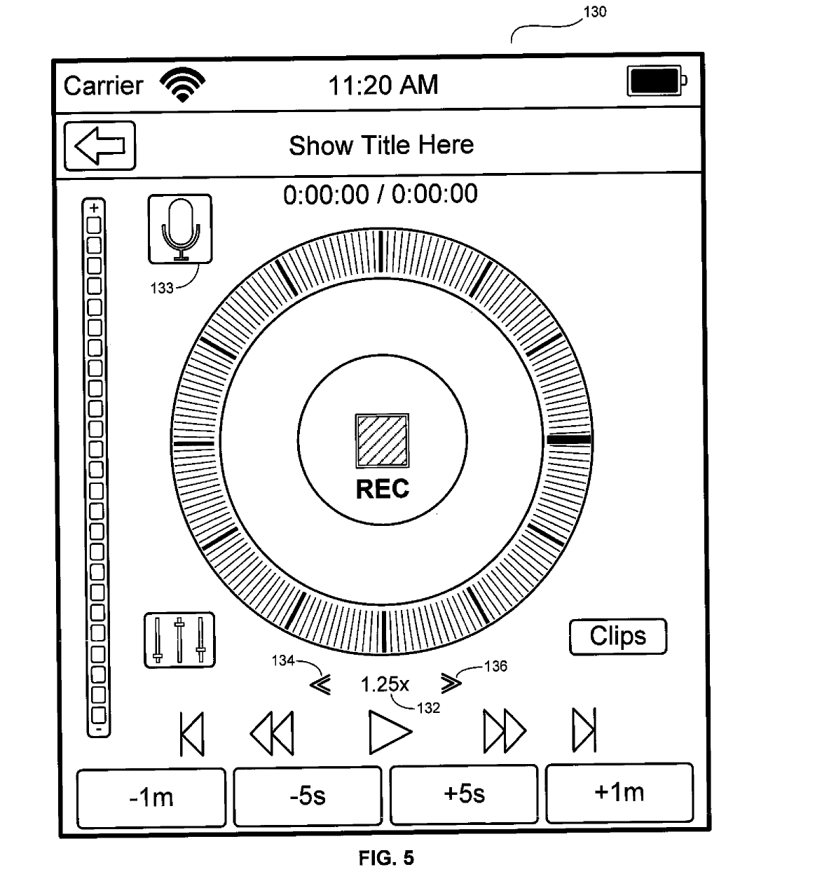

Now in reference to FIG. 2, exemplary logic to be executed in exemplary embodiments by a consumer electronics (CE) device such as a smart phone or tablet for creating and sharing audio content based on, e.g., a segment created by a user of a podcast, voice note, and/or audio book is shown. Beginning at block 50, the logic receives user input to invoke a tracking clock application in accordance with present principles to create audio content from e.g. a podcast or voice note. Then at block 52 the logic presents a user interface (UI) including a circular tracking clock, such as those described further below in reference to FIGS. 4 and 5. At block 54 the logic then receives user selection of audio content such as a podcast from, e.g., a library of audio content located on the CE device. It may be appreciated that receipt of a user's selection of audio content may be done in response to, e.g., selection of a selector element presented on the UI including the tracking clock such as a library selector element, which may then cause a pop-up window to be overlaid on the UI presenting one or more items of audio content which may then be selected by the user.

Regardless of the particular method of selection of the audio content at block 54, thereafter the logic moves to block 56 where the logic presents the audio content on the CE device using the audio content creation application (e.g. tracking clock application) described herein (e.g., through one or more speakers such as the speaker 28 described above) and also reflects the current position of playback of the audio content on the tracking clock of the application. In exemplary embodiments, playback may be reflected using a marker presented on and progressing around the dial/clock in real time as playback occurs. This marker will be described further in reference to FIG. 4 below.

Continuing in reference to FIG. 2, after block 56 the logic moves to block 58 where the logic receives user input at the tracking clock to rewind (and/or revert to an earlier portion and/or go backward and/or return to earlier point, etc. but in any case commonly referred to herein as “rewinding”) the audio content, though it is to be understood that the user input may be to fast forward (and/or advancing, skipping forward, etc., but in any case commonly referred to herein as “fast forwarding”) the audio content as well. Either way, the logic then proceeds to block 60 where the logic rewinds the audio content according to the speed at which the user manipulates the dial (e.g., moving the marker described above counter-clockwise on the dial using a finger at a quick/fast speed will rewind faster than rewinding at a relatively slower speed).

Then at block 62, after the content is rewound to the user's desired position, the logic receives user input to begin recording the audio content to create a new audio file and/or content beginning at the desired location, or alternatively at any point after the rewind location at which playback ensues from the rewind location upon selection (and e.g. release) of a record selector (to be described further below). After block 62, recording of the podcast continues until, at block 64, the logic receives user input to cease recording. Then at block 66 the logic presents (e.g., automatically without further user input after the user input to cease recording) a window that may be overlaid onto the tracking clock UI or alternatively a separate UI that includes one or more options for creation of the new content based on the recording as disclosed further below.

For instance, a user may enter a title for the new content. Another exemplary option is to add additional content to the new content after exiting the window and to continue recording from the end point of the last recording using the same audio content previously presented or another piece of audio content (e.g., selected from an audio library as described herein). As another example, one of more options may be to share the new content with one ore more people via, e.g. email, a social networking service (e.g., post a link to the new content in a status update on Facebook with a message from the user, and/or upload the content to Facebook), by posting it to a website or audio library accessible to others over a network, etc. Also note that in exemplary embodiments, the window may include a “cancel” or “delete” option to cancel creation of the new content and/or delete the segment that was recorded. Regardless of the particular options presented in non-limiting embodiments, it is to be understood that at block 68 the logic receives selections of one or more of the options, and then (e.g., automatically without further user input) creates the new content according to the options and stores the new content (e.g., in one or more locations on the user's CE device such as an audio library, and/or on a server such as the server 32 described above). Note that the new content recorded using a tracking clock application in accordance with present principles is sometimes referred to herein as a “clip” or “snippet.”

The logic then concludes at block 70 where the new content is provided to others if the user indicated as much, e.g., according to input for to provide it over a social networking service or via email as described above.

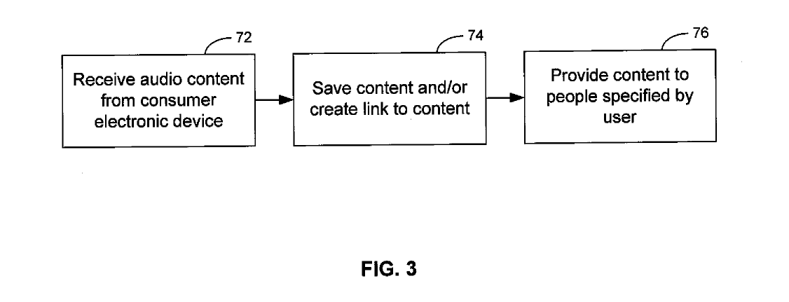

Moving on to FIG. 3, exemplary logic to be executed by a server such as the server 32 described above for sharing audio content created at a CE device presenting a tracking clock UI as described herein is shown. Beginning at block 72, the audio content (e.g., created from a podcast) or information pertaining thereto is received from the CE device, and then at block 74 the audio content and/or information pertaining thereto is saved and/or a link accessible over a network such as the Internet is created or determined for the content. Concluding FIG. 3 at block 76, the logic then provides the audio content or information pertaining thereto to people, CE devices, and/or services (e.g., a social networking service) as specified by a user at the user's CE device (e.g., as described above in reference to blocks 66 and 68 of FIG. 2).

Continuing the detailed description in reference to FIG. 4, an exemplary user interface including a circular dial and/or tracking clock in accordance with present principles is shown. Thus, a UI 90 includes a circular tracking clock 92 for enabling a user of the CE device on which the UI 90 is presented to access any portion or a segment of a podcast easily and quickly to playback the podcast from the navigated to portion. It may be appreciated from the UI 90 that the tracking clock 92 defines a closed circular periphery against which a user can move a finger to move forward and backward in time through the podcast. It may also be appreciated that the dial 92 includes plural segment lines 94 that are radially oriented thereon. Furthermore, as shown on the dial 92, at least every nth segment line 96 appears more prominently than adjacent segment lines, in this case by being bolded and presented relatively wider than other lines along the dial.

In addition to the segment lines 94 including nth segment lines 96, the dial 92 also includes a marker 98 that is understood to indicate a current location of play of the audio content (and thus, in some respects, may e.g. be similar to a hand on a temporal clock such that it indicates a time position). It is to be understood that the marker rotates around the tracking clock as the podcast plays and is user-manipulable to fast forward and rewind within the audio content as described herein. As may be appreciated from the UI 90, the marker 98 is presented on the dial relatively more prominently than other portions of the dial not including the indicator, including the segment lines 94 (and indeed every Nth segment line 96), and in this case is more bolded and relatively wider than the lines 94 and 96. However, it is to be understood that it may be presented relatively more prominently by, e.g. presenting it in another color such as a vibrant red, and/or by presenting it as blinking as it moves around the dial 92, and/or as another shape such as a triangular pointer.

Moreover, it is to be appreciated that manipulation of the marker 98 along the dial 92 in the clockwise direction fast-forwards the audio content and manipulation of the marker 98 in the counter clockwise direction rewinds the audio content, but that the opposite may be implemented in other embodiments if desired such that manipulation of the marker 98 along the dial 92 in the counter-clockwise direction fast-forwards the audio content and manipulation of the marker 98 in the clockwise direction rewinds the audio content.

Continuing the description of the UI 90 shown in FIG. 4, the tracking clock 92 includes a hollow ring 100 with an inner circular edge 102 spaced from and coaxial to an outer circular edge 104, the outer circular edge 104 abutting an inside edge of the circular portion of the dial 92 including the lines 94 and 96 as well as the marker 98. Furthermore, the inner circular edge 102 abuts and surrounds an outer circular edge of a red record button 106 in the middle of the dial 92 and is centrally disposed therein. It is to be understood that at least a portion of the red record button 106 may be a color such as red, but that not all of the record button 106 need be the same color and indeed some portions may be a shade of gray matching other areas of the UI 90. In the present exemplary embodiment, however, it is to be understood that a square-shaped record icon 108 at least is red, and furthermore that text “REC” 110 may indicate to a user that the button is a recording button. The text “REC” 110 may be red, a different color, or a shade of gray which turns white when recording is being executed to indicate recording.

Further describing the record button 106, it is to be understood that, once selected in accordance with present principles during playback of, e.g., a podcast to thereby record at least a portion of the podcast as described herein, the button 106 may pulse to indicate recording. The entire button 106 may pulse, or if desired only a portion thereof such as the icon 108 and/or text “REC” 110 may pulse. As but one example of how the button 106 or a portion thereof may pulse, it may appear to vibrate in and out, and/or slightly enlarge and then shrink to mimic a “heartbeat.”

Accordingly, as an example of how the dial 92 and button 106 may operate to record a segment of, e.g., a podcast or voice note (such as a voice note previously recorded by the user of the CE device on which the UI 90 is presented using a separate application or a record feature of the tracking clock application), or even other audio content such as an audio book recorded elsewhere, assume a user has selected a podcast for manipulation using the UI 90 from an audio library which is navigated to (or alternatively by causing the library to be opened using the selector element 111 including a musical note located at a top left portion of the UI 90 and/or back button 113 to return to a previously viewed audio library). The CE device then begins playback of the podcast with the marker 98 located at the top of the dial 92. As playback ensues without user manipulation, the marker 98 proceeds at a constant rate in a clockwise direction around the dial 92, while another portion of the UI 90 (in this case, an upper portion above the dial 92) presents a title 112 for the particular podcast and a current time/total time indicator 114 of the playback denoting the current playback time (in this case, five minutes and thirty one seconds) and the total length of the podcast (in this case, one hour, seven minutes, and ten seconds) in hh:mm:ss:s format (e.g., two hour digits appearing first left to right, then two minute digits to the right of that, two second digits to the right of that, and finally a tenth of a second digit to the far right). The marker 98 may then be selected at any point as it rotates clockwise around the dial 92 and moved (e.g. radially) using, e.g., touch input by the user's finger to rewind the audio content using the marker 98 counterclockwise to thereby rewind to a previously played portion, or fast forward the marker 98 clockwise to thereby fast forward to a later portion of the podcast, all the while the current time/total time indicator 114 may change accordingly as the marker 98 is manipulated such that the time position indicator is adjusted in real time with user manipulation of the marker 98. Thus, for instance, as a user fast forwards by advancing the marker 98, the current time indicator reflects the advance to, e.g., indicate a sixth minute position, then a seventh minute position, then an eighth minute position and so on as the user advances the marker 98 clockwise. Note that since the lines 94 and 96 represent time positions in the audio content, time indications may be changed on the UI 90 at the rate/speed corresponding to user movement of the marker 98 as determined by the CE device e.g. comparing the movement to the time increments of the podcast represented by the lines 94 and 96.

Still describing the present example, once the user has advanced the marker 98 to a desired portion of the podcast, the user may select the record button 106 which causes the CE device to begin recording a portion of the podcast such that the recorded portion forms a separate file from the original podcast file being played back. Once the marker 98 reaches a portion of the podcast at which the user wishes to cease recording, either by user manipulation of the marker 98 or by letting the marker 98 advance in real time as the podcast continues to play, the user may the select the record button 106 again to cease recording. At that time, an options window as referenced herein may be presented for editing metadata to be associated with the recorded clip. Furthermore, while recording ensues, not only will the button 106 pulse to indicate recording, but also the user may indeed advance the marker 98 even further to speed up recording of the podcast such that the segment once recording is ceased will include all of the portion encompassed by movement of the marker 98 from its initial positioning based on e.g. user input to its advanced position also based on user input, it being understood that this advantageously does not require the user to listen to the entire selected portion in real time to record it and that by arranging the marker 98 at a desired location, pressing the record button, advancing the marker to another position on the tracking clock, and then pressing the record button again, a “snippet” may thus be created and subsequently listened to at normal playback speed (e.g. of the original content) despite being “fast-forwarded” during recording.

Setting aside the example described immediately above, other features of the UI 90 will be described before moving on to FIG. 5. First, a vertical slider 116 may be disposed along a side edge of the UI 90, in this case the left edge. The vertical slider 116 is for adjusting the volume of playback of the audio content being presented, and thus even though not shown, may include a speaker symbol or icon at the bottom of or immediately beneath the slider 116 denoting that the slider 116 pertains to volume adjustment. It may be appreciated from the UI 90 that the vertical slider 116 may include a minus symbol at the bottom thereof and a plus symbol at the top thereof to denote that advancing a marker disposed along the slider 116 (not shown for clarity) in the upward direction will increase volume while advancing the marker of the slider 116 downward will decrease volume. Though it may not be appreciated from the back and white FIG. 4 filed herewith, dots/circles of the vertical slider 116 denoting volume increments may progressive change in color to denote low and high volume increments such that, e.g., dots at the bottom portion of the slider 116 appear dark red, and progressing upward the dots change to a lighter red, then from dark to light shades of orange, and then from dark to light shades of yellow. However, it is to be understood that still other colors may be used such as, from bottom to top in upward progression, shades of, e.g., purple, then shades of blue.

An equalizer (EQ) selector element 118 including an icon of equalizer sliders shown in the middle thereof may be presented on a bottom left portion of the UI 90 to the lower left of the dial 92 but to the right of the slider 116. The equalizer selector element 118 may be selected to cause a, e.g., 10-band EQ user interface such as those described herein to be presented that will change playback in real time as the EQ UI is manipulated. However, in non-limiting embodiments, adjusting the EQ may only adjust current playback of the audio such that any recording in accordance with present principles is recorded with the original tone/EQ settings.

Though not shown, it is to be understood that in other non-limiting embodiments, rather than presenting a single EQ selector element 118 or in addition to presenting as much, four EQ preset selectors may be presented on a tracking clock UI to directly control four EQ settings by denoting a “waveform” depicting the EQ setting for each particular preset, the particular four optionally being determined by a user or by default of the tracking clock application provider. In such as case (e.g., the four preset selectors), a user may select the respective preset to adjust it, or may push and hold any of the four preset selectors to cause a 10-band EQ editor to be presented to edit/adjust EQ settings. This 10-band EQ editor could be, but need not necessarily be, presented in landscape mode. In either case, once the user edits the settings and closes the EQ editor, the images of the four EQ preset selectors may be updated to reflect any respective changes input using the full 10-band EQ editor. For completeness and before continuing the description of the UI 90, it is to be understood that digital signal processing (DSP) and e.g. audio DSP units in particular may be used in conjunction with the EQ principles set forth herein.

Still in reference to FIG. 4, shown to the lower right of the dial 92 is a “clips” selector element 120 that is selectable to cause a library of recordings recorded using a tracking clock in accordance with present principles (e.g., previously saved recordings that do not necessarily have to all pertain to the same original podcast or voice note). Thus, selecting the clips selector element 120 allows a user to quickly and easily select previously recorded clips from, e.g., a clips library UI presented on the CE device also presenting the UI 90 and having the previously recorded clips stored thereon. The clips in the library may be listed, e.g., in alphabetical order and/or reverse chronological order according to when they were recorded. Furthermore, the clips in the clip library are understood to be selectable for playback themselves using a tracking clock UI, and may also be renamed or otherwise edited, and/or deleted.

The clip library “screen” that is presented may further include buttons for various social media/networking services that are selectable to share one or more of the clips via a respective social networking service, as well as an email selector element to share one or more of the clips via email. Thus, it may be appreciated that by selecting the clips selector element 120, quick (e.g. random) access to previously recorded clips is provided, although in other embodiments a tracking clock UI in accordance with present principles may instead or additionally include a “last” or “prev” selector element, selection of which will cause the last played or immediately previously played audio content to again be presented, and indeed it may be presented at the position where it was previously left off/stopped. Such a “last” selector element may be located on a lower left portion of a tracking clock UI and may include a play symbol with a two-way arrow beneath the symbol denoting a switch between two pieces of audio content is possible so that a user can toggle between two, e.g., podcasts to select portions thereof for recording.

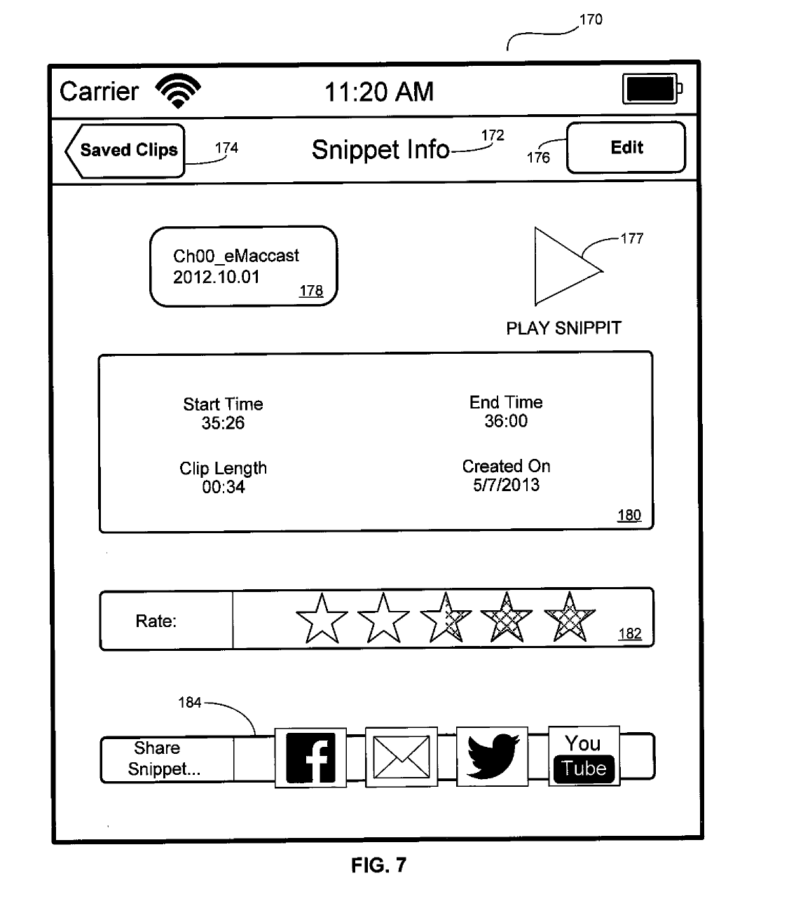

Furthermore, by selecting a metadata portion for a clip in the clip library, an information page for that particular clip may be caused to be automatically presented to present metadata to a user for that clip. Such an information page will be described further below in reference to FIG. 7.

Moving on with reference to FIG. 4, shown on the upper right portion of the UI 90 is a playback speed selector element 122. This element is selectable to cause, e.g., a pop up window overlaid on the UI 90 and/or a separate screen to be presented that allows a user to select a playback speed for the content (e.g., using a slider and marker in similar fashion to the slider 116 described above), and/or by selecting one of plural preset playback speed selectors. Thus, a user may playback a selected piece of audio content at a slower than normal speed (e.g., at half speed (0.5×)), at normal speed (1×), or at faster speed to listen to the podcast faster than normal (e.g., twice normal speed (2×)).

Shown beneath the dial 92 on the UI 90 are also plural playback controls 124 including a play selector, fast-forward and rewind selectors, and skip back and skip forward selectors. Additionally, an information selector 126 to directly access metadata information on the audio content currently being presented is shown on the top right portion of the UI 90. Lastly, plural selector elements 128 spanning the bottom of the UI 90 are shown. The selector elements 128 are understood to be manipulable to rewind and fast-forward within the audio content being played back a predetermined amount of time. In this case, four selector elements 128 are shown, and going from left to right respectively, cause playback to be rewound one minute (“−1 m”), rewound five seconds (“−5 s”), advanced five seconds (“+5 s”), and advanced one minute (“+1 m”).

Note however that these selector elements 128 may be customizable by a user such that a user may provide input to the CE device presenting the UI 90 to cause the selector elements 128 to correspond to different predetermined amounts of time than plus or minus five seconds and one minute to undertake present principles for advancing and rewinding user-specified predetermined amounts of time. Thus, the selector elements 128 may visually indicate these user-determined times rather than e.g. −1 m, −5 s, +5 s, and +1 m.

Continuing the detailed description in reference to FIG. 5, another exemplary tracking clock UI 130 in accordance with present principles is shown. It may be appreciated from FIG. 5 that many features and selector elements are evident that are similar to those described above, such as, e.g., a volume slider on the left portion of the UI 130, a back button on the top left portion, an audio content title on a central top portion, a current time/total time indicator, a circular tracking clock with lines including Nth lines being more prominently presented, a record button, a clips selector, an EQ selector, plural playback controls, and selector elements manipulable to rewind and fast-forward within the audio content being played back a predetermined amount of time, albeit not all elements and features are necessarily presented in precisely the same location as similar features were respectively presented on the UI 90 of FIG. 4. In addition, though not shown a marker for the dial is understood to be present and is similar in function and configuration to the marker 98 of FIG. 4.

Further distinguishing FIG. 5, rather than including a playback speed selector as described in reference to FIG. 4, the UI 130 shows text 132 indicating a current playback speed (in this case, one and one fourth as fast as normal (“1.25×”)), as well as a left selector 134 and a right selector 136 that are shown as being double arrows with one arrow being inside the other arrow but both inner and outer arrows pointing in the same direction (either left or right). Accordingly, by selecting the left selector 134, playback speed may be decreased and by selecting the right selector 136 playback speed may be increased. Such decreases and increases may be done incrementally (e.g., in quarters of the original playback speed such as 1.25×, 1.50×, 1.75×) or sequentially by one-one hundredths of decimals points in exemplary embodiments. Last, note that a microphone selector element 133 may be selectable by a user to initiate a voice note recording function to thereby record a voice note, where the voice note may then be saved and subsequently manipulated using, e.g., the UI 130, and indeed a voice note UI of the tracking clock application may be presented for the purpose of recording a voice note.

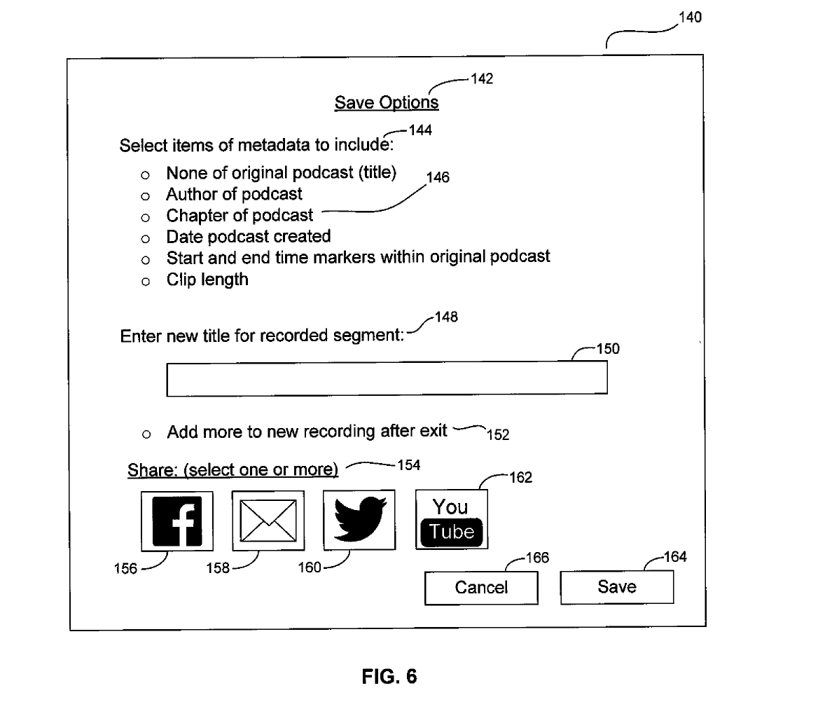

Now in reference to FIG. 6, an options window as referenced above is shown, it being understood that the options window may be presented automatically once recording has ceased in response to selection of, e.g., a pulsing record button on a tracking clock UI as described above. Thus, an options window 140 includes a text indicator 142 indicating “Save Options,” as well as a smaller text indicator 144 beneath the indicator 142 prompting the user to select one or more items of metadata 146 to include in the newly recorded e.g. podcast segment in accordance with present principles. In the exemplary embodiment shown, radio buttons for selection are presented, though other ways of selection may be used such as, e.g., selectable links.

Thus, the items/categories of metadata each with a respective radio button to the left thereof may include the name of the original podcast (e.g., the title), the author of the podcast, the chapter of the podcast (e.g., from which the recorded clip has been taken), the data the original podcast was created, start and end time markers/indicators for where the newly recorded clip was positioned in the original podcast, and the length of the newly recorded clip itself (which can be derived, e.g., from the start and end time markers).

Further, it is to be understood that though present principles recognize that the radio buttons above may be selected to include some or all of the metadata associated with each respective button, in some embodiments the user may not be given such a choice but instead some or all of the metadata described above may be automatically included.

The UI 140 of FIG. 6 also shows a text indicator 148 indicating to a user that the user may enter a new title for the newly recorded clip, and accordingly a text entry box 150 is provided so that the user may enter a name (e.g., using a pop up virtual keyboard presented on the display of the CE device under control of the CE device processor). However, in other embodiments no such option to input a new name for the newly recorded clip may be provided and instead, a default title may be assigned to the newly recorded clip that may, e.g., concatenate three pieces of metadata of the original piece of audio content as follows: Chapter_date_title. This automatically generated title may then be changed by the user at a later time.

Beneath the text entry box 150 on the UI 140 is an option 152 selectable using, e.g., a radio button for adding more audio content to the newly recorded clip and/or to continue recording, if desired, either from the same original audio content and/or from a different piece of audio content. Thus, present principles recognize that the tracking clock UIs described above may be used to again present an “original” piece of audio content from which to select another segment to have included in the same “newly” recorded clip presently being described e.g. at the end of the clip where the previous recording ceased.

Continuing the description of the UI 140, it also shows an indicator 154 prompting a user to share the newly recorded clip with others, if desired, over, e.g., Facebook (selector 156), via email (e.g., using a mobile email application)(selector 158), via Twitter (selector 160), and/or via YouTube (selector 162). Once one or more of the options described above in reference to the UI 140 have been selected, a save button 164 may be selected to e.g. automatically without further user input save the information, provide the new content over the specified social networking service(s), and, e.g., return to a tracking clock UI such as those described above. It is to be understood that based on, e.g., previously indicated tracking clock application settings, once the newly recorded clip is created, the original podcast clip may be deleted (e.g. automatically once the clip is saved or based on user input) from the memory of the CE device to thereby conserve storage space and only store the new portion that the user, e.g., deems relevant. However, should the user instead desire to cancel to return to the tracking clock UI and/or delete the newly recorded clip, a cancel button 166 may instead be selected.

Moving on to FIG. 7, an information “page” UI including metadata for a recorded clip such as the metadata described above in reference to FIG. 6 is shown. It is to be understood that this information page may have been caused to be presented on the CE device in response to selection of the clip or a portion thereof from a clip library as described herein.

Accordingly, FIG. 7 shows a UI 170 that includes, in a top portion of the UI 170, a text indicator 172 indicating that the metadata is information for the “snippet” selected e.g. from the clip library. A back button 174 including the text “saved clips” may also be presented in a top portion that is selectable to return to e.g. the clip library, and the UI 170 also includes a selectable edit button 176 that, when selected, may cause a window to be displayed to edit the metadata shown in the UI 170, to edit it directly on the UI 170, or to edit it e.g. using the UI 140 of FIG. 6. Also shown is a play “snippet” selector 177 that may be selected to initiate playback of the clip in accordance with present principles.

Now in reference to the metadata shown, a title 178 is shown, in this case being e.g. a title concatenated of three pieces of metadata of the original piece of audio content as described above (in this case, chapter (“CH00”) followed by the title (“eMaccast”) and then the date (“2012.10.01). A metadata box 180 is then shown beneath the title and may span almost the entire width of the UI 170 if desired, though need not necessarily do so. As may be appreciated from the box 180, it includes a start time of the clip in the original audio content in the upper left, an end time of the clip in the original audio content in the upper right, the length of the clip itself in seconds in the bottom left, and the date the clip was created on the bottom right. Though not shown in the black and white figure, the textual indicators for each of those pieces of metadata may be in a certain color (e.g., black or white), while the metadata itself may be in another color such as red.

As shown on the UI 170, beneath the box 180 is a clip rating indicator 182, which may be e.g. up to five stars but in this case has been given a rating (e.g., by the user) of two stars denoted by those two starts appearing in a yellow/gold color rather than e.g. a gray color that the other three stars are presented in. At the bottom of the UI 170 are provided various ways to share the clip as described above in reference to FIG. 6 (e.g., via Facebook, email, Twitter, and/or YouTube).

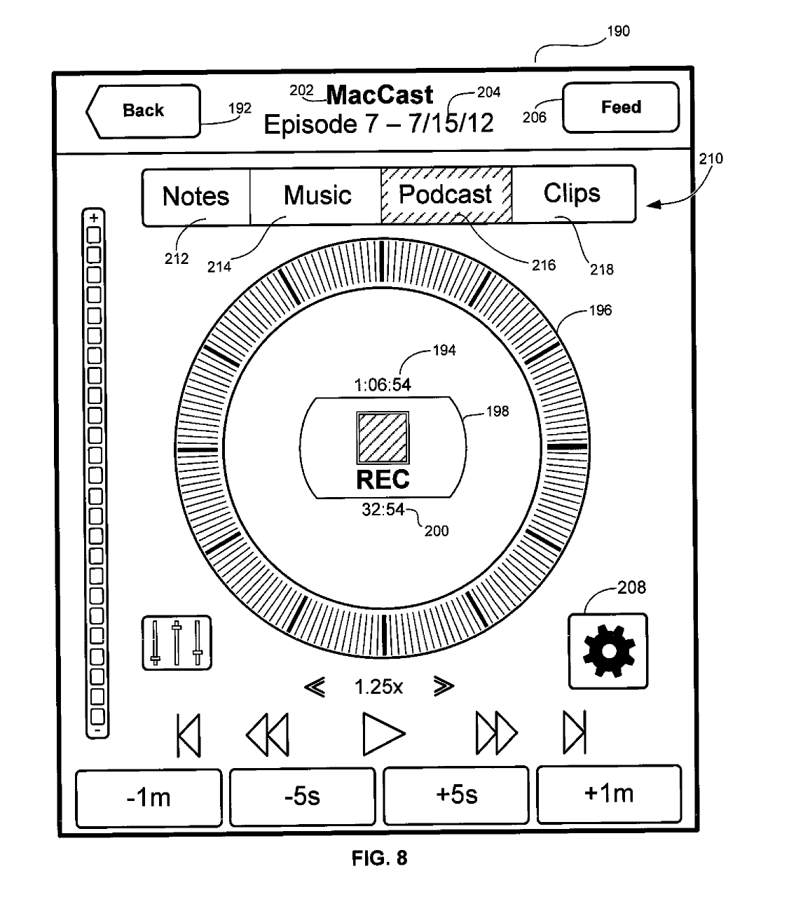

Moving on to FIG. 8, another exemplary tracking clock UI 190 for selecting portions of audio content to create a new “clip” of one or more portions is shown. It may be appreciated from FIG. 8 that many features and selector elements shown in FIG. 8 are similar to those described above in reference to FIGS. 4 and 5, such as, e.g., a volume slider on the left portion of the UI 190, a back button 192 on the top left portion substantially similar in function and configuration to the button 113 described above in non-limiting embodiments (save the button 192 includes the text “back” indicating that selection of the 192 will cause a “back” function to be executed in accordance with present principles), a circular tracking clock 196 with lines including Nth lines being more prominently presented, a record button, an EQ selector, plural playback controls, text and selectors pertaining to playback speed of audio content and adjustment thereof, and selector elements manipulable to rewind and fast-forward within the audio content being played back a predetermined amount of time. Nonetheless, present principles recognize that such features and elements may not necessarily be in precisely the same location on the UI 190 as similar features were respectively presented on other exemplary UIs described herein. In addition, though not shown a marker/current position indicator for the dial is understood to be present and is similar in function and configuration to, e.g., the marker 98 of FIG. 4.

Distinguishing FIG. 8 from previously described tracking clock UIs, the UI 190 includes a total audio content length indicator 194 in an inner portion of the dial 196 above a record button 198, the indicator 194 indicating in, e.g., hours, minutes, and seconds the total length of the audio content currently “loaded” or otherwise selected for playback and manipulation with the UI 190 in accordance with present principles. The UI 190 also includes a current audio content position indicator 200 in an inner portion of the dial 196 below the record button 198 that indicates in, e.g., hours, minutes, and seconds the current position of the audio content being, e.g., played back relative to the beginning of the content (e.g., in this case the current position is at thirty two minutes, fifty four seconds of audio content that totals one hour, six minutes, and fifty four seconds).

Further distinguishing FIG. 8, it may be appreciated that an audio content title 202 is shown on an upper, central portion of the UI 190. Immediately beneath that on the upper portion of the UI 190 is an indication 204 of further identifying information for the audio content, in this case indicating that the content is an episode in a series of content (e.g., episode seven) and further indicating a date that, e.g., the audio content was created and/or released by the content provider, and/or a date that it was initially stored on the CE device presenting the UI 190.

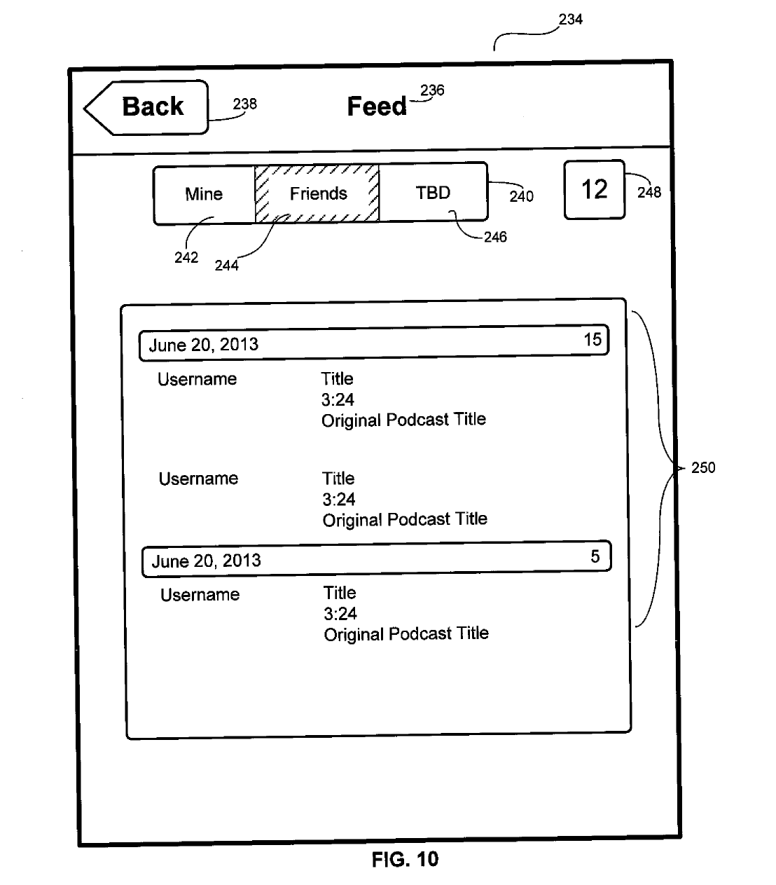

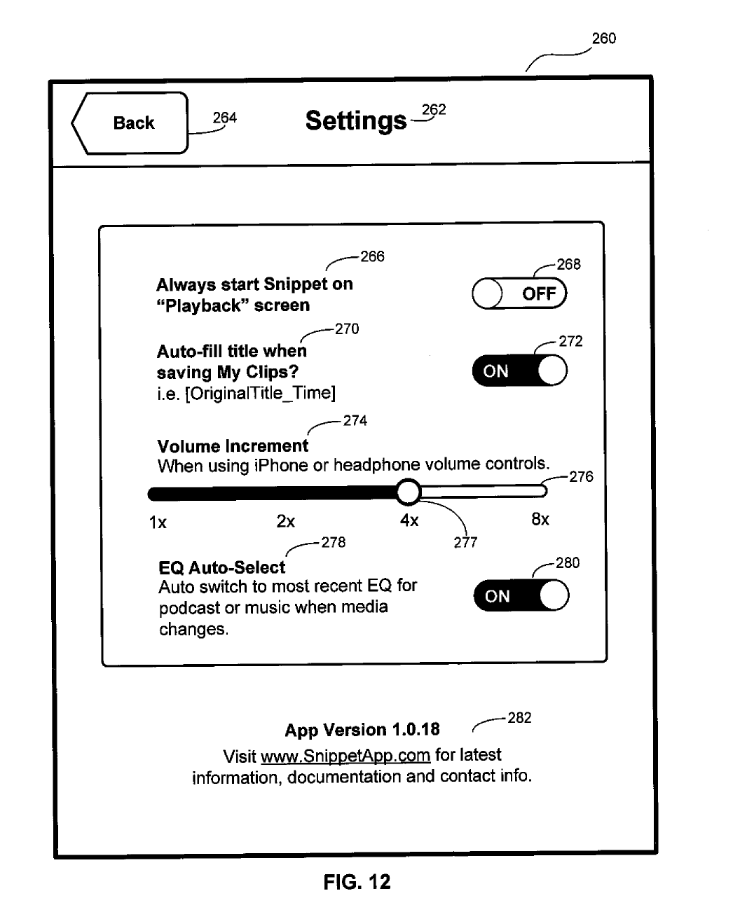

Also shown on the UI 190 is a feed selector element 206 and settings selector element 208. The feed selector element 206 is selectable to cause a feed UI (sometimes referred to herein as a “feed screen”) to be presented which shows at least one audio content feed selectable for playback, recording, and/or manipulation using a tracking clock UI in accordance with present principles. Feed UIs will be described further below such as in reference to FIG. 10. The settings selector element 208 is selectable to cause a settings UI to be presented which shows various user-configurable settings regarding playback, recording, and/or manipulation of content. This settings UI will be described further in reference to FIG. 12.

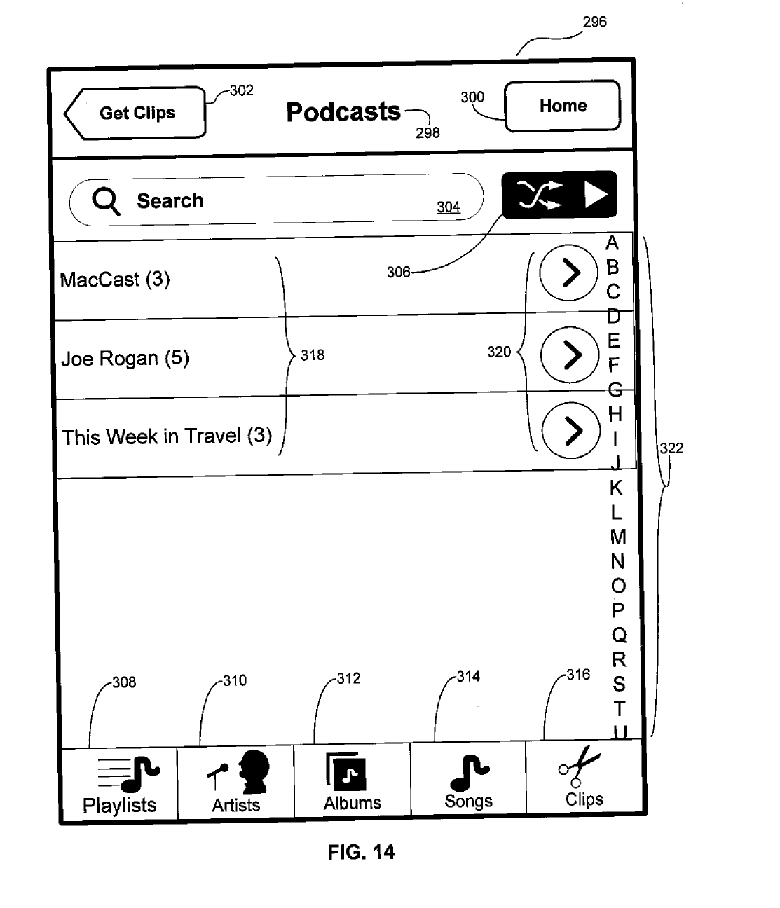

Still in reference to FIG. 8, the UI 190 also includes a row 210 of selector elements on an upper portion of the UI 190 but beneath the title 202, yet still above the tracking clock 196. The row 210 includes a notes selector element 212, a music selector element 214, a podcast selector element 216, and a clips selector element 218. These selector elements are each selectable to cause a most-recently selected (or, e.g., otherwise saved) audio content associated with each selector element to be “loaded” to thus playback, record, and/or manipulate the content or a portion thereof. Thus, for instance, should notes selector element 212 be selected, a most recently selected voice note may again be “loaded” for playback. Similar principles apply for loading a most recently selected music audio content by selecting the selector element 214, loading a most recently selected podcast by selecting the selector element 216, and loading a most recently selected audio clip by selecting the selector element 218 (e.g., portions of audio content previously recorded by manipulating the UI 190). Exemplary UIs that may be presented responsive to selection of these selector elements from the row 210 will be described below in reference to FIGS. 14, 18, and 20. Nonetheless, it is to be understood that in addition to or in lieu of the foregoing, in some embodiments, e.g., selection of any of the selector elements 212, 214, 216, or 218 may automatically change playback to any audio file associated with the respective category of the respective selector elements 212, 214, 216, and 218.

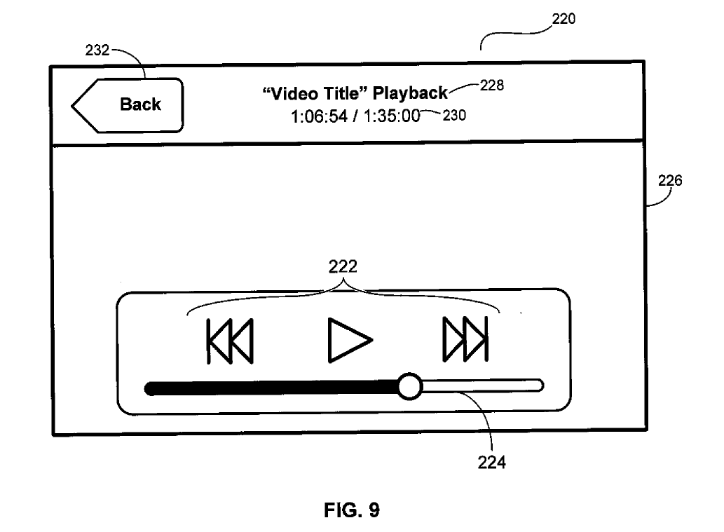

Now in reference to FIG. 9, an exemplary video playback UI 220 is shown for a podcast understood to be “loaded” for playback in accordance with present principles. It is to be understood that the UI 220 may be, e.g., toggled and/or presented responsive to a “tap” input to a display presenting the UI 190 of FIG. 8 or another tracking clock UI described herein, where the tap input is not directed to any particular element, indicator, or button presented on the UI 190. Thus, for instance, tapping a blank portion of the UI 190 not presenting anything other than, e.g., a background pattern for the UI 190 may cause the UI of FIG. 9 to be presented, and conversely tapping any portion of the UI 220 of FIG. 9 not presenting any indicators, elements, or buttons may cause the UI 190 of FIG. 8 to be presented. It may therefore be appreciated that should a user desire to, e.g., manipulate or record a portion of a podcast, the UI 190 of FIG. 8 may be toggled to, and if a user after causing playback desires to simply observe the podcast (e.g., audio and/or video) without the user's CE device presenting a tracking clock UI, then the UI 220 of FIG. 9 may be toggled to.

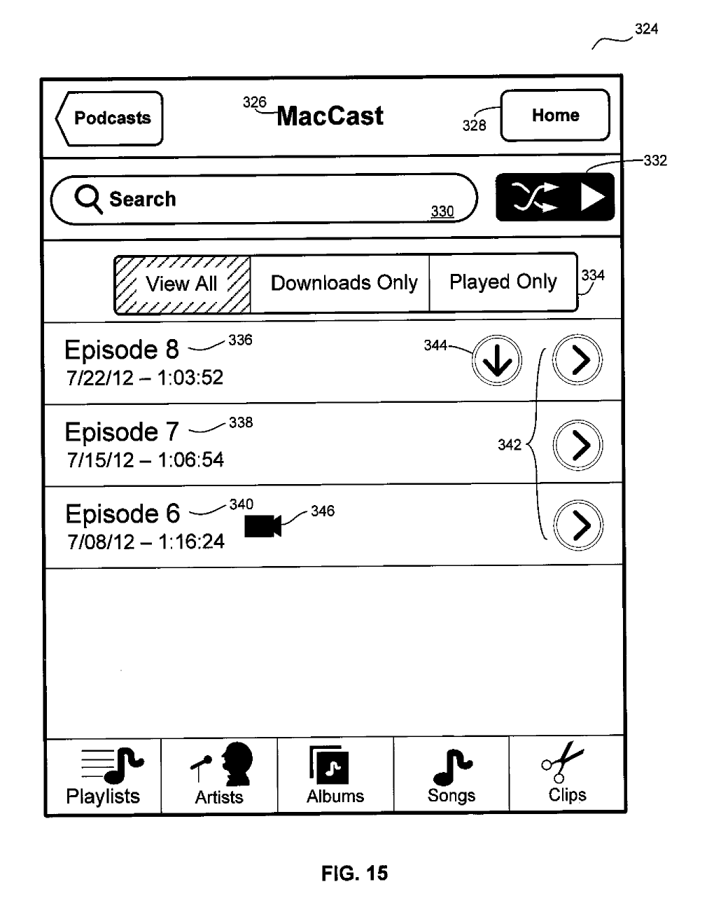

Further describing the UI 220 of FIG. 9, it may be appreciated that it includes plural playback controls 222 including a horizontal volume slider 224 for volume output adjustment. The UI 220 also includes a portion 226 for presenting video of audio video content, as well as a textual title indicator 228 indicating the title of the audio content on an upper portion of the UI 220 and a current position/total playback length indicator 230 immediately beneath the indicator 228 on the upper portion (e.g., in this case playback is currently at one hour, six minutes, and fifty four seconds of audio content that is one hour and thirty five minutes in total real time playback length). Also shown in FIG. 9 is a back button 232 that is selectable to, e.g., return to a previously presented tracking clock UI in accordance with present principles and/or return to a library of available audio content (such as that shown in, e.g., FIG. 15, 19, or 21 described below) based on, e.g., user configurable settings pertaining to which UI should be presented based on selection of the button 232.

Continuing the detailed description in reference to FIG. 10, an audio content feed UI 234 is shown, and includes text 236 on an upper central portion thereof indicating that the UI pertains to audio content “feeds” (and/or “Pod Catching”). Also included is a back button 238 that may be substantially similar in function and configuration to the button 232 of FIG. 9 in exemplary embodiments in that selection of it may cause an immediately previously presented screen/UI to again be presented. It is to be understood that feed UI 234 shows at least one audio content “feed” (such as, e.g., a file or piece of content stored on the CE device presenting the UI 234) that is selectable for playback, recording, and/or manipulation using a tracking clock UI in accordance with present principles. Furthermore, it is to be understood that audio contents presentable through this “feed” may be audio contents that were recorded using a tracking clock UI in accordance with present principles.

It may be appreciated from FIG. 10 that the UI 234 includes a row 240 of selector elements, the row 240 including a mine selector element 242, a friends selector element 244, and a to be determined (TBD) selector element 246. In exemplary embodiments, the row 240 is located at least partially on an upper left portion of the UI 234 and at least partially beneath the text 236. The mine selector element 242 is selectable to cause one or more audio contents associated with the user of the CE device presenting the UI 234 to be presented thereon (e.g., audio content created by the user, downloaded using an audio account associated with a user, stored locally on the CE device, stored in a cloud storage area associated with the user, etc.). The friends selector element 244 is selectable to cause one or more audio contents of friends of the user that are accessible to the user using the CE device to be presented on the UI 234. The TBD selector element 246 is selectable to cause one or more audio contents of another category not specifically determined to be presented on the UI 234. The text “TBD” on the selector element 246 may change if and when, e.g., a user specifies (using, e.g., a settings menu) a category of audio content to be associated with the selector element 246 such that selection of the element 246 causes one or more audio contents associated with the selected category to be presented on the UI 234.

Still in reference to FIG. 10, just to the right of the row 240 on an upper portion of the UI 234 is a selector element 248 indicating a number, in this exemplary case twelve. The number may reflect/denote e.g., the number of friends of the user responsive to the element 244 being selected, the number of shares of content by friends of the user for a piece of content or the total number of shares for all pieces of content, the number of shares the user has shared e.g. if the element 242 has been selected, the number of contents that have been uploaded for sharing, the number of friend comments for any piece of content, the number of new friend comments since the most-recent viewing of comments by the user, etc. Whatever the number may denote in varying embodiments as described herein, it is to nonetheless be understood that selection thereof causes the respective information associated with the number to be presented (e.g. overlaid on the UI 234 or presented on a separate UI).

Also shown on the UI 234 are plural audio content information areas 250 presented in a list-like fashion, with each respective area being associated with a respective audio content and indicating a name of a user that created or made accessible to the CE device the respective audio content, and/or the user otherwise associated therewith. Each respective area 250 also includes an indication of the content's title, the length of the audio content, and the original title of the underlying content from which the respective audio content 250 was recorded using a tracking clock UI. Also note that the audio content areas 250 may be listed on the UI 234 chronologically as shown, reverse-chronologically, and/or based on whether they are associated with the user of the CE device (e.g., those audio contents being presented first toward the top of the list) or associated with a friend of the user (e.g., those audio contents being presented on the UI 234 beneath any audio contents associated with the user), or any combination thereof (e.g., listing them both chronologically and based on with whom the audio contents are associated). Last, note that a number on the same row as the date and on a right-portion of the UI may indicate e.g., the number of shares of that piece of content, the number of clips that have been created from that piece of content or the original content from which the piece was derived, etc.

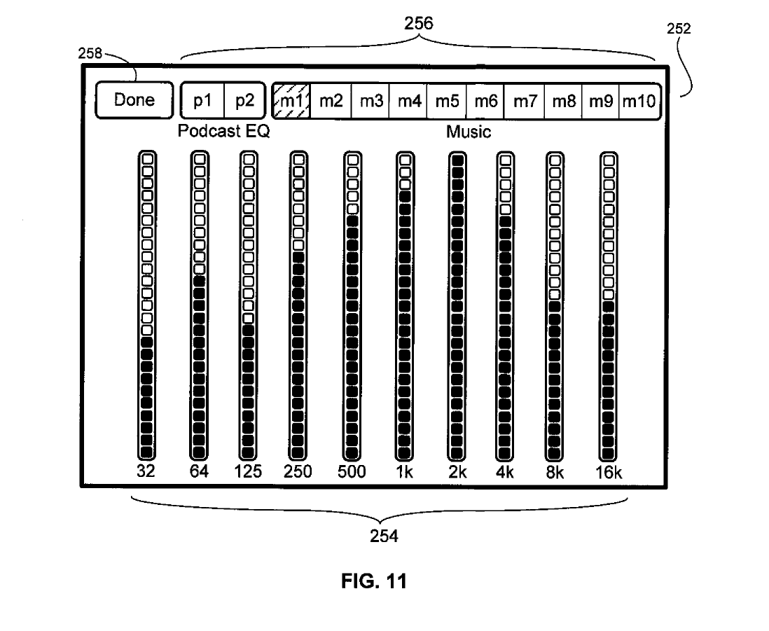

Turning now to FIG. 11, an exemplary ten band audio equalizer UI 252 is shown. The UI 252 may be presented, e.g., responsive to selection of an EQ button/selector element from a tracking clock UI described herein. Thus, the UI 252 includes ten vertical sliders 254 each for e.g. adjusting the amplitude of audio signals at various frequencies. In this case, from left to right, the sliders are for low to high frequencies (e.g., left to right, thirty two Hz, sixty four Hz, one hundred twenty five Hz, two hundred fifty Hz, five hundred Hz, one thousand Hz, two thousand Hz, four thousand Hz, eight thousand Hz, and sixteen thousand Hz). It is to be understood that each of the sliders 254 includes plural circular elements disposed vertically therealong that, based on input to the respective slider (e.g., via a touch screen presenting the UI 252), may be “filled in” (e.g., instead of being black, filled in with another color) based on user input directed to a desired point along the slider to indicate the desired level for that EQ setting.

For example, a user may touch one of the sliders 254 at or near the bottom thereof and slide his or her finger upward vertically therealong to cause circular elements for that particular slider to be filled in as the user slides his or her finger to and/or past each circular element to indicate a desired level for that EQ setting. A downward slide can reduce the level of EQ setting for that frequency in the same fashion (e.g., by sliding downward beginning at or around the highest-most “filled in” circular element). Accordingly, this type of slide input to manipulate the circular elements of each slider are recognizable by a processor of the CE device presenting the UI 252 thereon to thereby adjust the EQ setting based on the upward or downward slide input and also cause the presented slider to reflect the EQ level accordingly. Note that the same “sliding” principles similarly apply to, e.g., the volume sliders and any other sliders disclosed herein in that the levels may be adjusted accordingly.

Still in reference to FIG. 11, the UI 252 also includes plural selector elements 256 that are selectable for manipulating EQ configurations for e.g. two podcast EQ settings and ten music EQ settings (e.g. different frequencies). (Thus, e.g. the UI 252 may include e.g. two sets of presets in the “header” such that one set pertains to a preselected podcast and the other for audio presets that automatically synch up with the content selected for play, and in this regard the EQ capabilities disclosed herein are “smart EQ.”) The UI 252 also includes a done selector element 258 that is selectable to return to a UI that was previously presented (e.g., immediately before presenting the UT 252). Thus, for example, if the UI 252 was invoked by selection of an EQ selector element presented on a tracking clock UI, selection of the done selector element 258 may cause that tracking clock UI to again be presented.

Now in reference to FIG. 12, a settings UI 260 showing various user-configurable settings for playback and recording options in accordance with present principles is shown. It is to be understood that the settings UI 260 may be presented responsive to selection of, e.g., the selector element 208 described above, although present principles recognize that it may be presented responsive to selection of other settings selector elements presented in accordance with present principles as well. Regardless, it may be appreciated that the UI 260 includes text 262 indicating “Settings” on an upper central portion thereof to thus indicate that the UI 260 is a settings UI, along with a back button 264 that may be substantially similar in function and configuration to, e.g., the back button 238 described above. The UI 260 also includes a setting 266 for always starting what is referred to as a “snippet” (e.g., a recorded portion of audio content that was recorded using a tracking clock UI in accordance with present principles) on a “playback” screen e.g., when the playback screen is initially presented. In non-limiting embodiments, the playback screen may be a tracking clock UI, the UI 220 of FIG. 9, or another suitable playback screen. Regardless, note that the setting 266 includes an on/off selector element 268 that is selectable to toggle between an on position and an off position depending on whether a user desires the setting associated therewith to be set to on or off. In the present instance, the on/off selector element 268 is set to off for the “always start Snippet on ‘playback’ screen” setting.

The UI 260 of FIG. 12 also includes a setting 270 for whether to automatically create a title to be associated with a snippet when the snipped is saved, e.g., to a folder such as a folder titled “My Clips.” An on-off selector element 272 is thus provided for the setting 270 for a user to provide input thereto depending on whether the user wishes a title to be automatically created. Also shown on the UI 260 is a setting 274 for (e.g. automatically configuring) volume output of a snippet when played (e.g., when played back on a smart phone and/or through headphones). A horizontal slider 276 is thus provided for adjusting volume from low to high, left to right using a slider 277 to adjust from, e.g., normal or recorded output to any multiple thereof (e.g., the slider 276 in this case goes up to eight times normal volume output).

The UI 260 shows yet another setting 278, this time for automatically selecting and/or switching EQ settings to a most recent EQ setting from another audio content that was played when playback changes from one audio content to another rather than, e.g., initiating playback at EQ settings saved for and unique to the next audio content to be played back. Thus, an on/off selector element 280 is provided for turning the setting 278 on or off based on user input. Last, note that the UI 260 includes text 282 on a bottom portion thereof identifying the version number of the tracking clock application, as well as providing a web address that may be visited for the most recent information, documentation, and contact information concerning the tracking clock application.

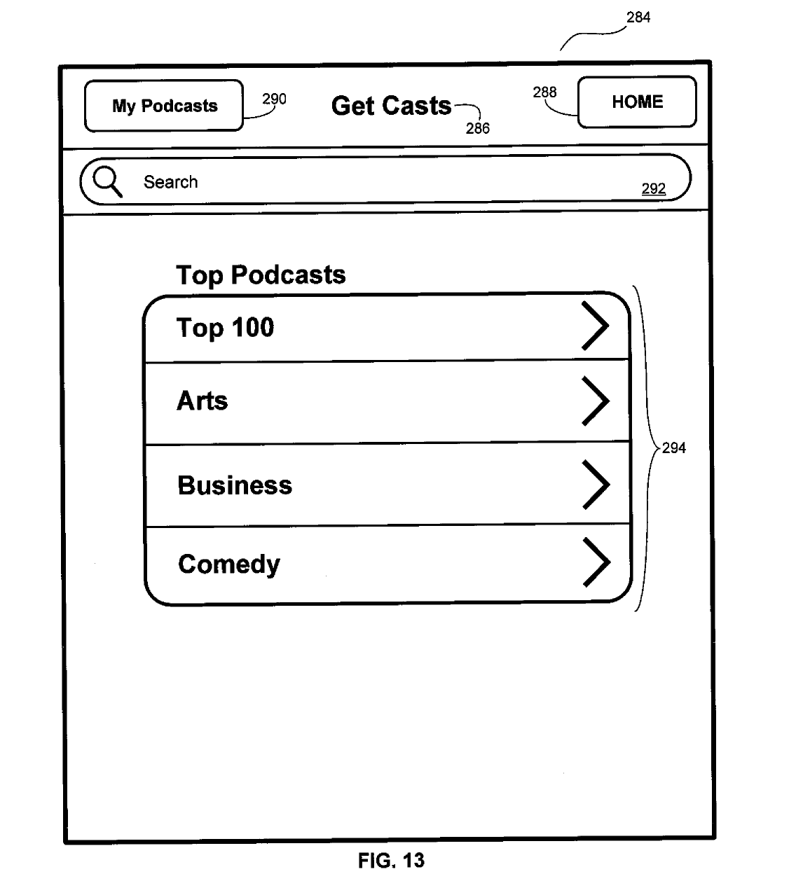

Continuing now in reference to FIG. 13, an exemplary audio content acquisition UI 284 is shown. It is to be understood that the UI 284 may be selected in accordance with present principles (e.g., presented responsive to selection of a “Get Audio Content” button or a “Get Clips” button on a tracking clock UI) to thereby acquire audio content (from, e.g., the Internet, and/or an application store or marketplace accessible to the CE device presenting the UI 284, etc.) to save the content to the CE device, and also playback and/or record snippets thereof using a tracking clock UI in accordance with present principles.

Thus, as shown the UI 284 includes text 286 indicating “Get Casts” since, in the present instance, the UI 284 pertains to acquiring podcasts. The UI 284 also includes a home selector element 288 on an upper right portion thereof that is selectable to cause a home screen associated with a tracking clock application to be presented, and/or a tracking clock UI to be presented. The upper left portion of the UI 284 includes a my podcasts selector element 290 that is selectable to cause a library of audio content accessible to the CE device presenting the UI 284 to be presented. Shown beneath the text 286 is a search box 292 that is selectable to, e.g., cause a virtual keyboard to be overlaid on at least a portion of the UI 284 to enter search parameters to search for available content. Additionally, a Top Podcasts section 294 includes plural selector bars that are each selectable to cause at least one audio content associated with the category denoted by each of the bars to be presented for selection of the content to thus, e.g., download and save the content to the CE device. The exemplary categories for each of the four selector bars shown are Top 100 for the most downloaded one hundred podcasts, Arts for art-related podcasts, Business for business-related podcasts, and Comedy for comedy-related podcasts. Accordingly, for example, should the Arts bar be selected, another UI may be presented in response thereto that lists at least one podcast related to the arts that is selectable for download to thereafter be played back and manipulated using a tracking clock UI in accordance with present principles.

Now describing FIG. 14, an exemplary audio content UI 296 is shown that may be presented responsive to selection of, e.g., one of the bars from the section 294 described above and/or the podcast selector element 216 also described above in reference to FIG. 8. The UI 296 includes text 298 indicating “Podcasts,” a home selector element 300 that in some embodiments may be substantially similar in function and configuration to the button 288 described above, and a “Get Clips” back button 302 that, responsive to being selected, may cause the UI 284 of FIG. 13 to (e.g., again) be presented. The UI 296 also includes a search box 304 that is selectable to, e.g., cause a virtual keyboard to be overlaid on at least a portion of the UI 296 for a user to thereby enter search parameters to search for available audio content within the sub-categories shown. Immediately to the right of the search box 304 is a shuffle play button/selector element 306 for e.g. random playback of content within that screen/reflected thereon when the element 306 is selected. Note that buttons/selector elements for shuffling similar to the function undertaken when the element 306 is selected are also presented on the UIs of e.g. FIGS. 15, 18, and 19 as well.

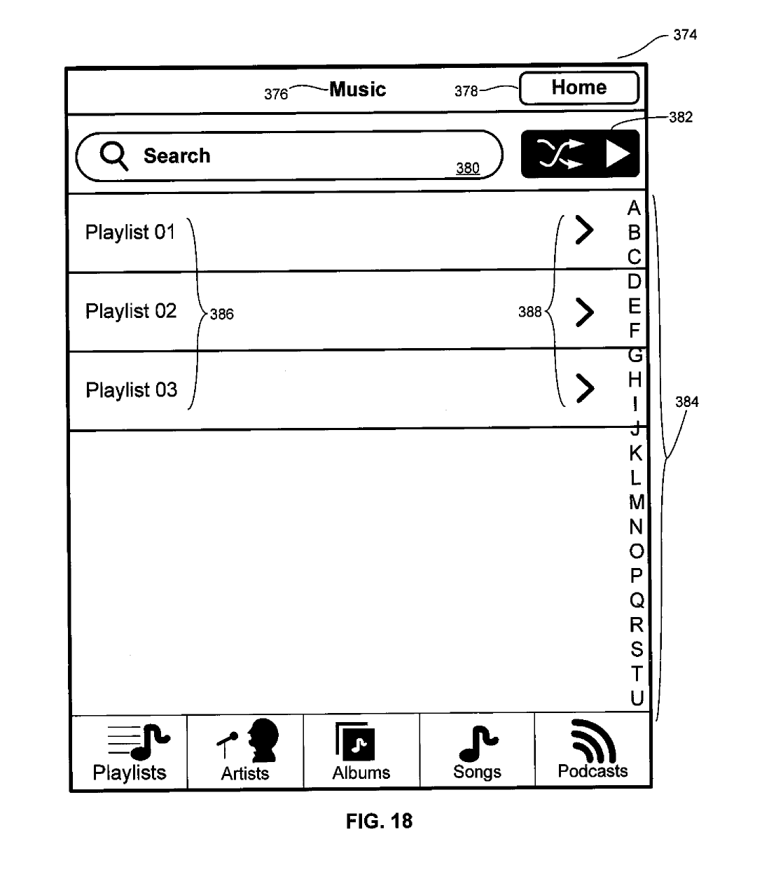

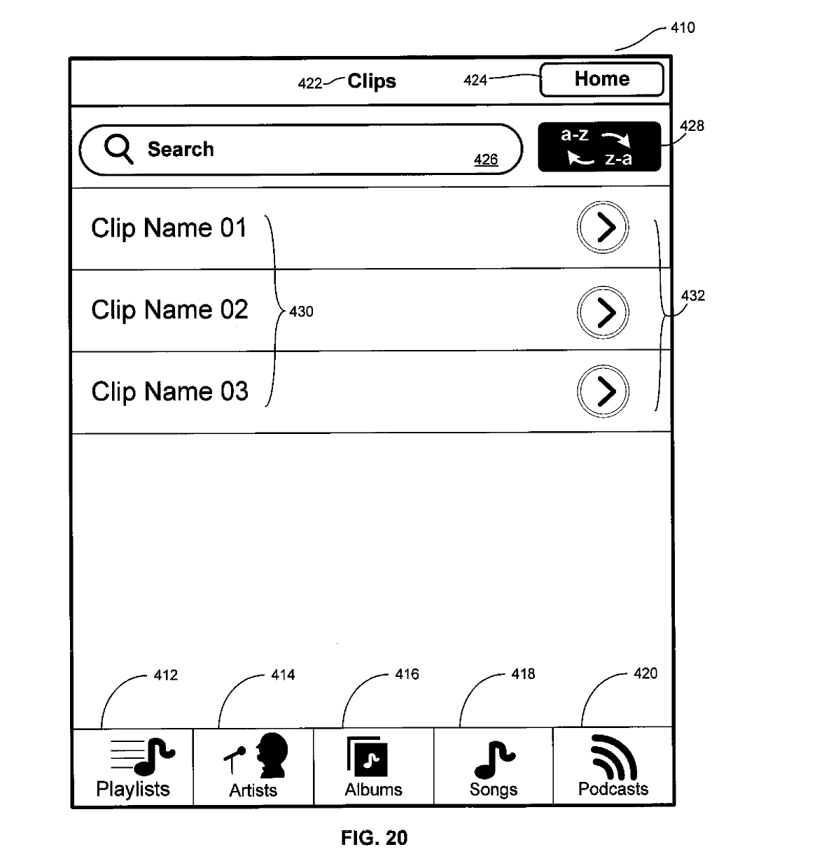

Also shown on the UI 296 is a playlists selector element 308, an artists selector element 310, an albums selector element 312, a songs selector element 314, and a clips selector element 316 (present principles recognizing that many of the following UIs such as those described in reference to FIGS. 15, 18, 19, and 20 may contain selector elements substantially and respectively similar to the elements 308, 310, 312, 314, and 316 in function and configuration, as may be appreciated from those respective figures themselves). Thus, selection of the playlists selector element 308 may cause a UI listing playlists of content to be presented, such as the UI shown in FIG. 18 to be described below. Selection of the artists selector element 310 may cause a UI listing artists associated with available audio content to be presented, selection of the albums selector element 213 may cause a UI listing content albums of available audio content to be presented, and selection of the songs selector element 314 may cause a UI listing available songs to be presented. Furthermore, selection of the clips selector element 316 may cause a clips page of snippets that have been created using a tracking clock UI to be presented, such as the UI shown in FIG. 20 described below.

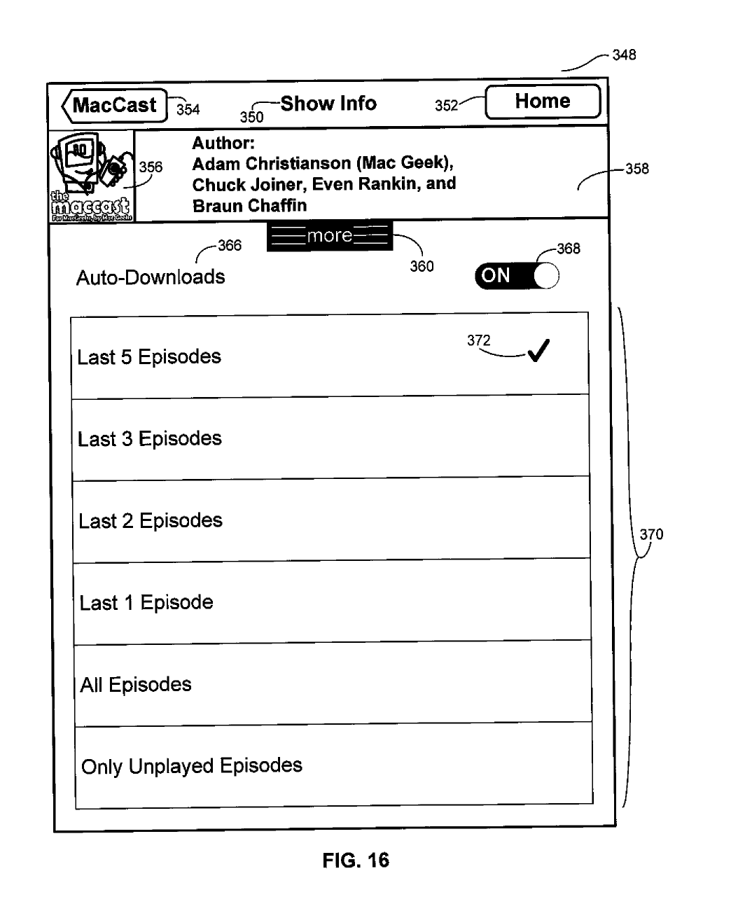

Still in reference to the UI 296 of FIG. 14, it includes three exemplary sub-category panels 318 of available podcasts, although more or less sub-categories may be presented in accordance with present principles. Each of the respective sub-category panels are selectable on at least a portion thereof to cause individual audio contents associated therewith to be presented. As an example, selection of the panel for Joe Rogan may cause a list of available audio contents for Joe Rogan to be presented, where in this case the number of audio contents—five—associated with the sub-category Joe Rogan is shown in parentheses on the respective panel for that sub-category next to the text “Joe Rogan.” Also note that each of the respective panels 318 can include a respective right arrow 320 on a right portion thereof that, rather than being selectable to cause individual audio contents associated with that sub-category to be presented, is instead selectable to cause an information UI to be presented that presents information related to the sub-category of the panel on which the selected right arrow is presented. An example of such an information UI will be described below in reference to FIG. 16. But regardless, note that should there by more panels 318 than presentable UI space on the UI 296 based on the size of the display of the CE device, thus requiring the need to scroll at least some of the panels 318 on and off the screen to be viewed, a user-manipulable alphabet listing 322 may be presented on the UI 296 for a user to slide his or her finger up and down therealong to navigate available panels 318 based on their arrangement in alphabetical order (e.g., based on the first letter of the first word for a given sub-category).

Moving on to FIG. 15, an exemplary UI 324 is shown that may be presented responsive to, e.g., selection of one of the panels 318 described above at a portion other than the portion containing one of the right arrows 320. Accordingly, it is to be understood that the panel for “MacCast” from the UI 296 has been selected to thus cause the exemplary UI 324 to be presented responsive thereto. Note that the UI 324 includes text 326 denoting the sub-category “MacCast,” a home button that may be substantially similar in function and configuration to the home button 300 described above, a search box 330 that may be substantially similar in function and configuration to the box 304 described above in that e.g. search parameters may be entered to search with the “MacCast” category, and a shuffle selector element 332 that may be substantially similar in function and configuration to the shuffle selector element 306 described above.

The UI 324 of FIG. 15 also includes a row 334 of selector elements that are each selectable to cause a certain class and/or sorting of audio content to be presented, in this case either all audio content associated with MacCast, only downloaded contents associated with MacCast, or only previously played contents associated with MacCast. Further, beneath the row 334 of selector elements is a listing of available contents associated with MacCast. It is to be understood that, in the exemplary embodiment shown, the “view all” selector element from the row 334 has been selected and thus all available contents associated with MacCast are provided in a list-like fashion on the UI 324 in reverse-numerical episode order.

It may be further appreciated that at least a portion of panel 336 may be selected to thereby initiate playback of Episode Eight, at least a portion of panel 338 may be selected to thereby initiate playback of Episode Seven (and indeed the highlighting of panel 338 denotes that this particular panel has been selected in the present instance so that it may be played back or otherwise opened in a tracking clock home screen and/or tracking clock UI), and at least a portion of panel 340 may be selected to thereby initiate playback of Episode Six. Additionally, note that each of the respective panels includes a date such as, e.g., the date the content was created and/or downloaded, as well as the total real time playback time for the content.

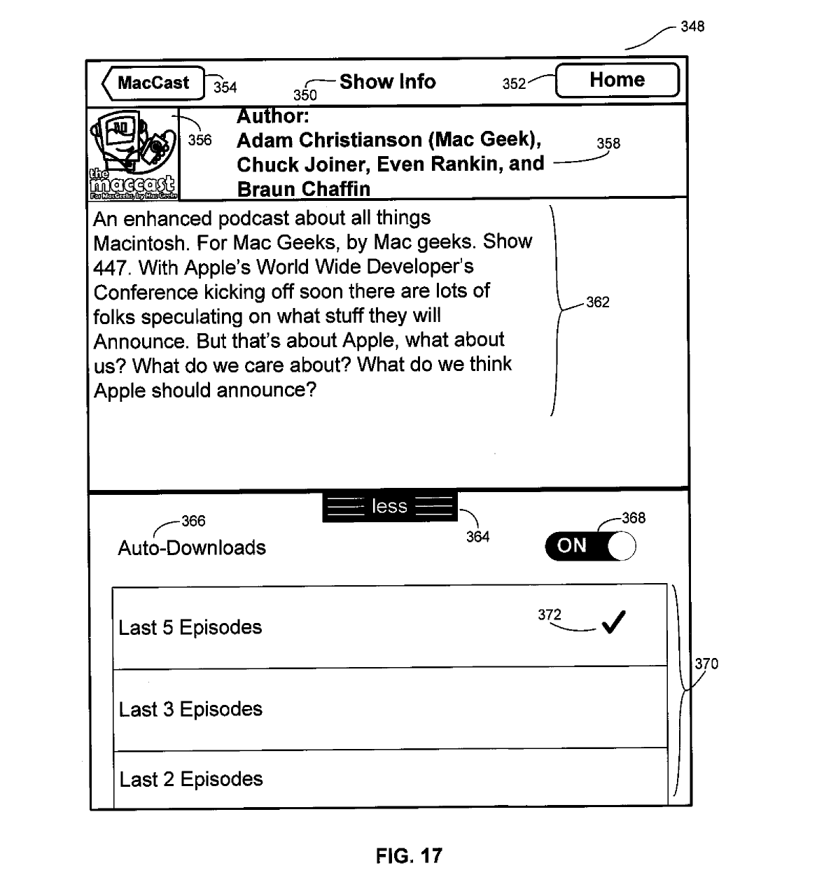

Still other features may be evident on the panels 336, 338, and 340. For example, all three of these panels include respective right arrows 342 (e.g., that may be colored blue) that are respectively selectable to cause additional information and/or metadata associated with that particular content to be presented and/or to adjust settings associated with that content, an example of which will be described in reference to FIGS. 16 and 17. As another example, the panel 336 includes a down arrow 344 (e.g., that may be colored green) that indicates that Episode Eight has either been downloaded or is available for download. Accordingly, the arrow 344 in some exemplary embodiments may indicate e.g. that the episode denoted by the panel 336 has not yet been downloaded to the CE device presenting the UI 324 and also provides the ability for a user to quickly and easily download (e.g. “grab”) the associated content. As one last example, it may be appreciated from the UI 324 that panel 324 includes the image 346 of a video camera, denoting that Episode Six is not just audio content but also includes accompanying video content that is presentable on the CE device presenting the UI 324.

Now in reference to FIGS. 16 and 17 jointly, a UI 348 is shown that includes text 350 denoting that what is shown on the UI 348 pertains to information about audio content, it being understood that the UI 348 may be presented responsive to selection of an arrow 342 from FIG. 15. It is to be further understood that the UI 348 may pertain particularly to information, metadata, and/or adjustable settings for content associated with the panel 338 of FIG. 15 was presented and selected to thus cause the UT 348 to be presented. Regardless, in addition to the text 350, the UI 348 includes a home button 352 that may be substantially similar in function and configuration to the home buttons described above, as well as a MacCast back button 354 that is selectable to cause the UI 324 to be presented. In addition, the UI 348 includes a MacCast icon, and next to that on an upper portion of the UI 348 is metadata/content information 358 regarding the particular selected MacCast content. In this case, the metadata 358 includes information about the authors of the content, as well as at least one author's nickname.

However, additional metadata may be presented if desired based on selection of a more selector element that may (e.g. functionally) act as a pull-down menu (e.g., may be virtually pulled down using finger input such that additional metadata slides down and is overlaid on the UI 348). Thus contrasting FIGS. 16 and 17, at FIG. 16 the metadata 358 described above and the more selector element 360 are shown, but in FIG. 17 the more selector element 360 has been pulled down to thereby cause additional (e.g., general) metadata 362 to be presented, including a textual description of the content associated therewith and questions meant to evoke the reader's curiosity to thus listen to and/or watch the associated content. Also note that, rather than the more selector element 360 shown in FIG. 16, a less selector element 364 is shown beneath the additional metadata 362 that may be pushed or swiped up by a user to cause the additional metadata 362 to no longer be presented on the UI 348 to thus, e.g. revert back to the configuration shown in FIG. 16.

Also shown on the UI 348 of FIGS. 16 and 17 is a setting 366 for auto-downloads, denoting that if an on/off selector element 368 is set to on (which in the present instance, it is set to on), then episodes of MacCast will be automatically downloaded to the CE device presenting the UI 348, it being understood that if the element 368 is set to off then episodes will not be automatically downloaded and should be done so manually by the user. Even further, in addition to setting automatic downloads to on or off using the element 368, the number of episodes that are to be automatically downloaded may be determined based on selection of one of the selectable panels 370 also shown on the UI 348. Thus, for instance, respective panels, if selected, may denote from top to bottom in list-like fashion that the most recent five episodes are to be downloaded (which is the case in the present instance, the check mark 372 denoting that the five episode panel has been selected), the most recent three episodes are to be downloaded, that the most recent two episodes are to be downloaded, only the most recent episode is to be downloaded, that all episodes are to be downloaded, or that only un-played episodes (e.g., episodes that have not been played back on the CE device presenting the UI 348) are to be downloaded. Last, as may be appreciated from FIG. 17, not all of the panels 370 may fit the UI 348 at one time in some embodiments when the additional metadata 362 is presented and thus panels may be scrolled down to, e.g., using touch-input such as vertical swiping.

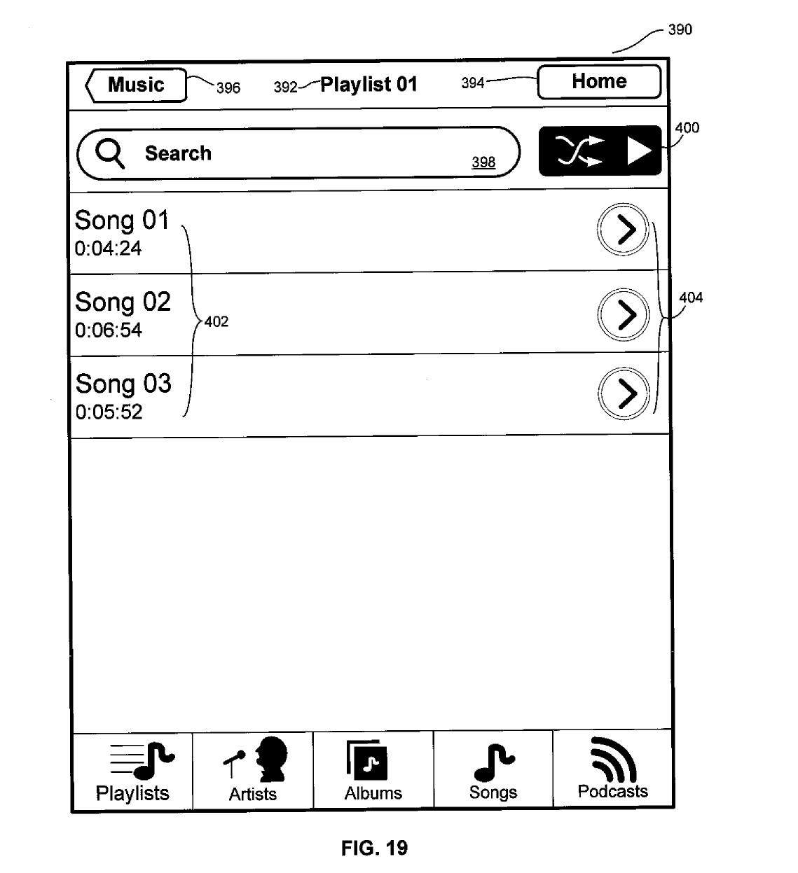

Now describing FIG. 18, an exemplary audio content playlist UI 374 is shown that may be presented responsive to selection of, e.g., the music selector element 214 described above in reference to FIG. 8 (e.g. and may pertain to different sort filter views such as playlists, artists, albums, and songs). The UI 374 includes text 376 indicating that the UI 374 pertains to music content, as well as a home button 378 that may be substantially similar in function and configuration to the home buttons described above. The UI 374 also includes a search box 380 that may be substantially similar in function and configuration to the box 304 described above in that search parameters may be entered to search with the music category/contents, a shuffle selector element 383 that may be substantially similar in function and configuration to the shuffle selector element 306 described above, and a user-manipulable alphabet listing 384 that may be substantially similar in function and configuration to the listing 322 in that, e.g., it is manipulable to scroll available panels 386 each associated with a particular playlist of music content. Furthermore, it is to thus be understood that the panels 386 are selectable to cause the respective playlist associated with the selected panel to be presented, an example of which will be described in reference to FIG. 19 below. However, before moving on to FIG. 19 note that arrows 388 are respectively located on each of the panels 386 and denote that selection of one of the panels will cause the playlist associated with that panel to be presented by, e.g., moving the UI 374 off screen left to right while (e.g., simultaneously) moving the UI 390 of FIG. 19 on screen left to right.

Now in reference to FIG. 19, a UI 390 is shown that may be presented, e.g., responsive to selection of one of the panels 386 described above. It includes text 392 indicating that the UI 390 pertains to a particular playlist of music content (in this case, “Playlist One”), a home button 394 that may be substantially similar in function and configuration to the home buttons described above, a search box 398 that may be substantially similar in function and configuration to the box 304 described above and may be used to search e.g. for particular songs, and a shuffle selector element 400 that may be substantially similar in function and configuration to the shuffle selector element 306 described above.

As also shown on FIG. 19, the UI 390 includes plural song panels 402 that are each selectable to initiate playback of a song associated with that panel and also present, e.g., a tracking clock UI during playback of the song (and/or the UI 220 with information about the selected song or still other UIs). Note that each of the panels 402 includes text indicating the title of the song and the total real time playback length of the song on left portions thereof, as well as respective right arrows 404 (e.g., that may be colored blue) on right portions thereof that are selectable to cause a UI to be presented that includes metadata/information about that particular song. Thus, it is to be understood that selection of one of the panels 402 at the arrow 404 may cause metadata to be presented, whereas selection of one of the panels at any portion thereof other than the respective arrow 404 may initiate playback.

Continuing the detailed description in reference to FIG. 20, an exemplary clips page UI 410 is shown, it being understood that in some embodiments the clips page UI 410 may be presented responsive to selection of the selector element 316 described in reference to FIG. 14 above, and/or responsive to selection of a clips selector element as shown at the bottom right of some of the other UIs described herein, such as, e.g., the UI 324. Further, note that at least some selector elements that may be substantially similar in function and configuration to respective elements 308, 310, 312, and 314 are shown on the UI 410 as well (and indeed some of the other UIs such as the UI 390 of FIG. 19), including a playlists selector element 412, an artists selector element 414, an albums selector element 416, and a songs selector element 418. Also note that a podcasts selector element 420 is shown at the bottom right of the UI 410 and may be selected to then present, e.g., the podcasts UI 296 of FIG. 14 in some exemplary embodiments.

Further describing the UI 410 of FIG. 20, the UI 410 includes text 422 indicating that the UI 410 pertains to clips (e.g., recorded “snippets” created using a tracking clock UI as described herein), a home button 424 that may be substantially similar in function and configuration to any of the home buttons described above, a search box 426 that may be used to search clips and/or snippets based on, e.g., keywords and/or metadata, and a sorting selector element 428 that is selectable to sort the clips in various ways as described further below. However, note that in other embodiments another element may be presented in place of the element 428 that includes the text “view” and may also include a bi-directional up/down arrow that, responsive to being selected, may cause sorting functions to be presented (e.g., in a drop-down screen/menu, being overlaid on the UI 410, or replacing the UI 410).

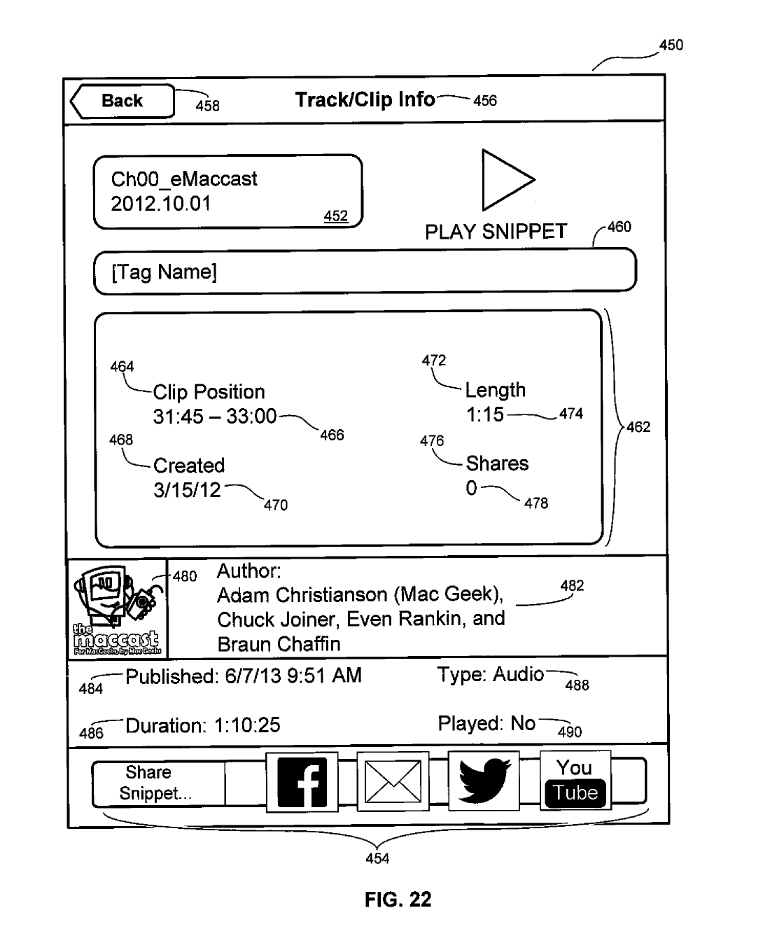

As may also be appreciated from the UI 410, at least one but in the present instance three clip panels 430 each representing a clip are presented, e.g., in the order top to bottom in which they were created (e.g., based on date and/or time). It is to thus be understood that, in exemplary embodiments, anytime clips/snippets are saved (and/or are when done so automatically), the clips may be stored on the CE device presenting a tracking clock UI and/or the UI 410 such that they are subsequently accessible for presentation on the CE device by manipulating the UI 410. Accordingly, when input is directed to one of the clip panels 430 at any portion thereof other than the respective (e.g., blue) right arrows 432, the respective clip associated therewith may be presented on the CE device (e.g., playback may be initiated) automatically without further user input. However, should user input be directed to one of the arrows 432, metadata and/or additional information regarding the clip may be presented, an example of which will be discussed shortly in reference to FIG. 22.

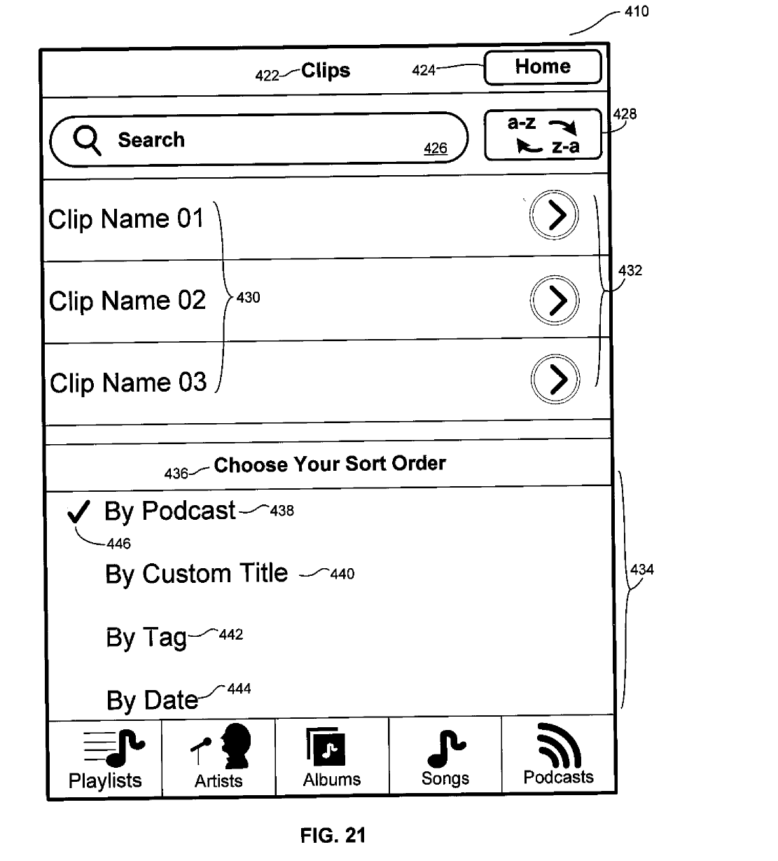

However, before describing FIG. 22, reference is made to FIG. 21 which again shows the UI 410, but with an overlay portion 434 that may be automatically overlaid onto a least a portion of the UI 410 responsive to selection of the sorting selector element 428 should a user desire to sort the clips presented on the UI 410. Accordingly, the portion 434 includes text 436 indicating that one of the options presented on the portion 434 to be shortly described may selected to choose, arrange, and/or rearrange the order of the clips as presented on the UI 410. Thus, a by podcast selector element 438 is shown on the portion 434 as being selected, along with a by custom title selector element 440 for sorting by titles indicated/created by a user (e.g. thereby sorting alphabetically based on the user-specified titles), a by tag selector element 442 for sorting by various tags for the clips that may have been created automatically and/or based on user input, and a by data selector element 444 for sorting chronologically or reverse-chronologically based on the (e.g., creation and/or download) date of the clip

As shown in FIG. 21, the check mark 446 indicates that the by podcast selector element 438 has been selected in this exemplary embodiment, and thus the clips may be sorted based on the original respective podcasts (or other audio content) from which the clip was created. Furthermore, note that in some embodiments once a selector element such as the element 438 is selected, it may be also be presented in a different color than the other elements 440, 442, and 444 to indicate it has been selected. Regardless, the sorting based on podcast may be done, e.g., based on respective creation and/or download dates of the original podcasts, alphabetical order based on the respective names of the original podcasts, by respective tags associated with the original podcasts, etc., or any combination thereof as may be determined by a user (e.g., using a settings UI) and/or automatically based on software settings e.g. determined by the provider of the tracking clock UI software and/or UI 410.

Now describing FIG. 22, a track and/or clip information UI 450 is shown. It is to be understood that in at least some respects, the UI 450 may include aspects, selector elements and/or buttons that may be substantially similar in function and configuration to similar respective aspects, selector elements, and/or buttons shown on the UI 170 of FIG. 7. For instance, a play snippet selector element is shown on the UI 450 and may be similar in function and configuration to the play snippet selector element 177 of FIG. 7. As other examples, the UI 450 shows a clip title 452 and various sharing selector elements 454 for sharing the subject clip as described herein via, e.g., Facebook, an email application, Twitter, and/or YouTube.

Distinguishing the UI 450 from the UI 170 of FIG. 7, text 456 indicates that the UI 450 pertains to “Track/Clip Info” for, e.g., a clip from the UI 410 described above. A back button 458 is also shown, where the button 458 may be substantially similar in function and configuration to any of the back buttons described above in exemplary embodiments (e.g., the back button may be selected to cause the immediately previous screen/UI to again be presented, in this case the UI 410). Also shown on the UI 450 is a name section 460 that may include, e.g. a tag name, automatically created name, and/or user-designated name for the clip. Optionally, the name section 460 may receive input directed thereto from a user based on, e.g., a tap directed to the section 460 that in turn causes a virtual keyboard to be presented so that a user can enter and save a name for the subject clip directly at to the section 460 to thus change the name of the clip, rather than having to do so via another UI.

In addition, beneath the section 460 is a metadata portion 462. The metadata portion 462 can show various types of metadata pertaining to the subject clip, including any of the metadata described herein. In the exemplary portion 462 shown, the portion 462 includes a clip position text 464 and a corresponding indication 466 in minutes and seconds of the time position span of the original audio content from which the clip was derived, a created text 468 and a corresponding date 470 that the clip was created, a length text 472 and corresponding length 474 in minutes and seconds of the clip itself, and a shares text 476 with a corresponding number 478 of shares of the clip (e.g., times that a clip was shared via any of the exemplary sharing means described herein such as Facebook or email). In the present instance, the subject clip has not been shared, and thus the number 478 is zero.

Still describing the UI 450, beneath the metadata portion 462 is an exemplary MacCast icon 480 and additional metadata/content information 482 regarding the authors of the original audio content from which the subject clip was derived. In addition to an indication of the authors of the original audio content, the UI 450 may also include other metadata related to the original audio content, such as a date and time 484 the original content was published, a duration 486 of the original content, a type 488 of the original content (in the present instance, audio, though present principles recognize that other types may include, e.g., audio video content), and a played indicator 490 indicating whether the original content has been played (e.g., played/presented in its entirety on the CE device presenting the UI 450).

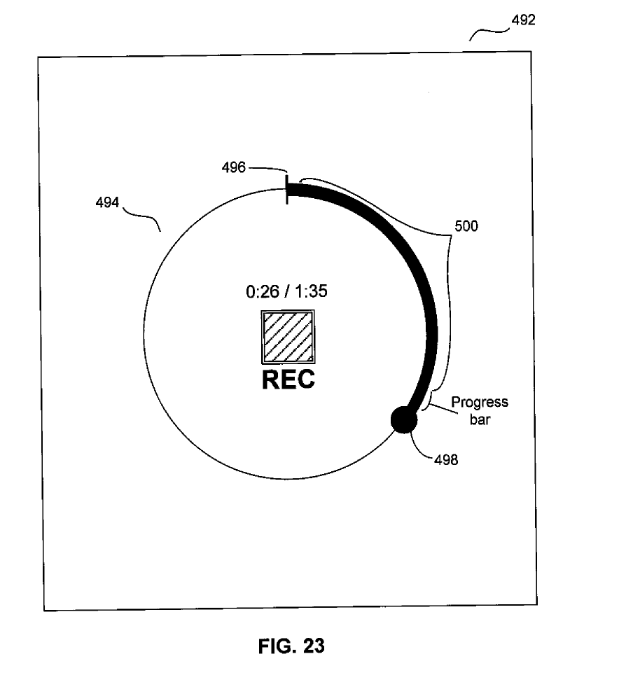

Turning to FIG. 23, an exemplary “home” UI in accordance with present principles is shown that is generally designated UI 492 and may include many of the same aspects as tracking clock UIs described above. Thus, it is to be understood that although not all aspects and elements from the tracking clocks described above are shown again on the UI 492 (such as, e.g., the vertical slider 116 and selector elements 128), any and/or all aspects and elements shown in the tracking clock UIs of the present application and described above may be included on the UI 492 though not specifically shown.

With specific reference to what is shown in FIG. 23, the UI 492 includes a circular scroll bar 494. The circular scroll bar 494 may include a marker 496 on an upper portion thereof and a movable (e.g., scrollable) indicator 498 that may be circular or spherical. It may be appreciated from FIG. 23 that beginning at the marker 496 and progressing clockwise around the circular scroll bar 494 (though it is to be understood that in other embodiments progression may be counter-clockwise if desired), the indicator 498 may continue to and/or progressively move clockwise around the scroll bar 494 as playback of audio content ensues. Furthermore, the indicator 494 is understood to be manipulable in accordance with present principles to navigate within selected audio content such that moving it in the clockwise direction advances (e.g. fast forwards) to a later (temporally from the beginning) portion of the selected audio content while moving in the counter-clockwise direction e.g. rewinds within the selected audio content.

Additionally, note that as shown on the UI 492, a thicker, highlighted, and/or filled-in portion 500 of the scroll bar 494 is shown and is understood to in part denote the current position within the audio content being manipulated in that the portion 500 indicates audio content progress (e.g. a progress bar) up to the portion of the circular scroll bar 494 on which the indicator 498 is presented. Thus, e.g., the portion 500 represents portions of the audio content located at positions within the audio content that are temporally prior (relative to the beginning of the selected audio content) to the current playback and/or manipulation position represented by the indicator 498. In some embodiments, the circular scroll bar 494 at portions not reflecting progress (e.g. not including a thicker, highlighted, and/or filled-in portion such as the exemplary portion 500) may be one color while the filled-in/enlarged portion may be another color to thus visually distinguish progress. Furthermore, the indicator 498 may be the same color as the portion 500 but may be yet another color different from any other portion of the scroll bar 494.

Accordingly, as may be appreciated from the UI 492, the indicator 498 and portion 500 provide a desirable, relatively large surface area for which user input may be directed for ease of manipulation of the selected audio content in accordance with present principles. Content manipulation is further aided by the UI 492, as indeed with the tracking clocks also described above, by providing an accurate and easily discernable means for manipulating content.

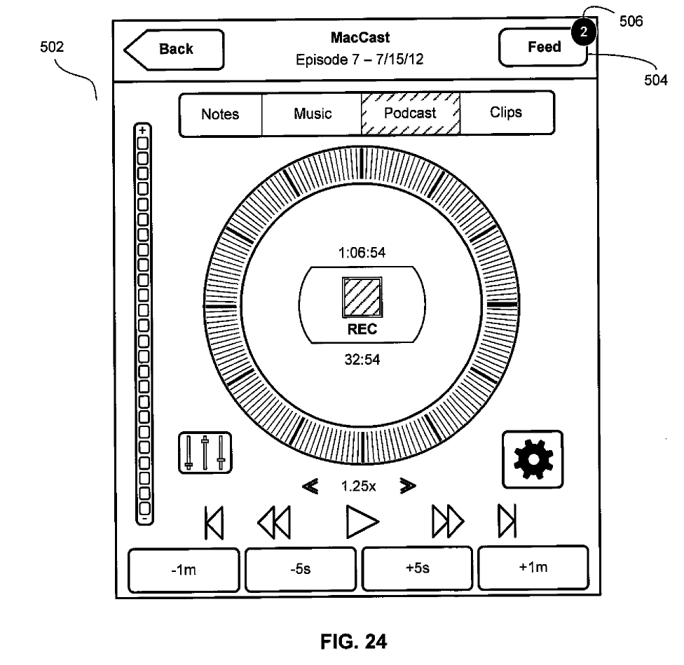

Before moving on to FIG. 24, it is to be understood that although not shown on the UI 492 or the tracking clock UIs described herein, any of the UIs described herein are understood to in some embodiments include an advertising area (e.g., immediately under/beneath the selector elements 128) that may be e.g. an advertising banner spanning the width of the UI or only occupying a portion thereof. This area may thus be e.g. an advertising feed, scrolling banner, etc.

Now in reference to FIG. 24, another tracking clock UI 502 is shown. The tracking clock UI 502 may in exemplary embodiments be substantially similar in function, configuration, and/or presentation as the other tracking clock UIs described herein (e.g., may include the selector elements described above with reference to the other tracking clock UIs). Distinguishing FIG. 24, it may include a feed selector element 504 that may be substantially similar in function and configuration to the feed selector element 206 save that the feed selector element 504 includes a notification/indicator 506 that indicates the number of audio content feeds that are selectable for playback, recording, and/or manipulation using a tracking clock UI in accordance with present principles from e.g. a feed screen UI. Nonetheless, in some embodiments it is to be further understood that the notification 506 indicates some (but not necessarily all) audio contents that include new portions (and e.g. entirely new audio contents that are available) that have not been previously played back and/or manipulated by a user (e.g., if a podcast provider provides another chapter of a podcast since the most recent playback of the podcast on the CE device presenting the tracking clock UI 502).

The notification 506 may thus indicate the number of “new” contents (e.g. in the present instance, two). Furthermore, the notification 506 may include at least a portion that is a color such as red, blue, or green to visually distinguish it so that a user may easily discern that new content and/or portions thereof are available.

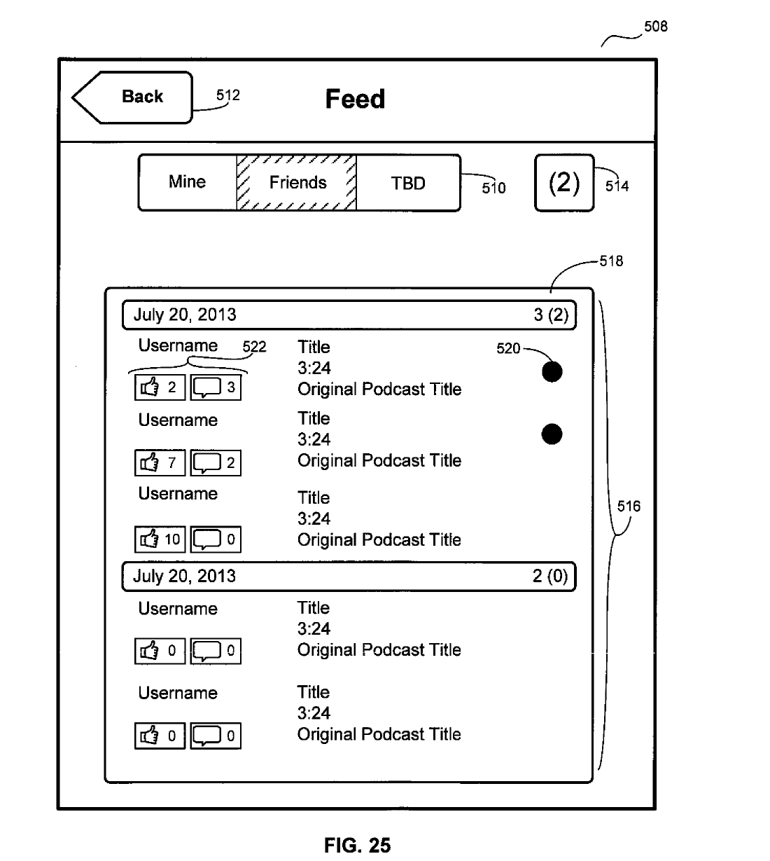

FIG. 25 is another audio content feed UI that may in at least some respects be substantially similar in function and configuration to the UI 234 of FIG. 10. Thus, a UI 508 is shown. It includes a row 510 that may be substantially similar in function and configuration to the row 240 described above, a back button 512 that may be substantially similar in function and configuration to the back button 238 described above, and a numbered selector element 514 this time including parenthesis that may be substantially similar in function and configuration to the element 248 described above and in the present instance may indicate the total number of new audio contents that have not been selected for playback and/or manipulation yet on the CE device presenting the UI 508. The element 514 may be selectable to cause only these “new” contents to be presented on the UI 508 rather than all contents in some embodiments.

As may be appreciated from FIG. 25, the UI 508 also includes plural audio content information areas/panels 516 that in at least some respects may be substantially similar in function and configuration to the areas 250 described above and may be selectable to cause the content associated therewith to be played back in accordance with present principles. However, distinguishing the UI 508 from previous feed screens described herein, to the right of the date Jul. 22, 2013 on a right-portion of the UI 508 are two numbers 518, one without parenthesis and to the right of that with parenthesis. The first number without parenthesis indicates the total number of audio contents associated with that particular date, while the number within parenthesis indicates the number of new audio contents that have not yet been selected for playback and/or manipulation that are nonetheless associated with that date. These “new” audio contents are understood to in some embodiments already be downloaded to the CE device presenting the UI 508 but in other embodiments may be available but have yet to be downloaded to the CE device. Also denoting that certain audio contents are “new” in accordance with present principles, a (e.g. orange colored) circle or dot 520 may be presented on a right portion of the panel associated with the respective audio content denoting that the content is “new.” If desired, selection of this circle/dot 520 may even cause the content to be automatically downloaded to the CE device should it have not already been downloaded.

Further describing the “new” contents (e.g. in the present instance on the UI 508 the top two audio content panels are “new” contents), it is to be understood that the text including metadata information for the respective contents may be presented in white text, whereas text on the other panels (e.g., the bottom three on the UI 508) may be presented in gray text to indicate that these contents have been previously selected for playback and/manipulation. In addition, note that plural social networking selector elements 522 may be associated with each content panel should the UI 508 and/or tracking clock application be linked to a social network. The elements 522 may thus include e.g. like selector elements and/or comment selector elements that may each include icons denoting as much (e.g., a Facebook thumb's up or comment icon) as well as a number respectively denoting the number of likes and/or comments associated with the piece of content based on the user and the user's friend's social networking activity. Furthermore, such like selector elements may be selectable to present information related to the “likes” such as a list of friends who have “liked” the content (e.g., overlaid on the UI 508) and/or for the user to “like” the content directly from the UI 508, and such comment selector elements may be selectable to present information related to the comments such as a list of friends who have commented on the content and/or the comments themselves (e.g. overlaid on the UI 508) and/or to provide a social networking comment directly from the UI 508. Note that selector elements for more than one social networking service may be presented on each panel, if desired, and that they need not all necessarily pertain to either “likes” or comments but other social networking features as well. However, regardless of what precisely the selectors 522 may pertain to in varying embodiments as disclosed herein, present principles recognize that these elements thus improve the sharing capability of the user and the sharing characteristics of the UIs and content clipping disclosed herein.

It may now be appreciated based on the preceding description that portions of, e.g., podcasts, voice notes, audio books, music, and still other audio content, may be selected and that those portions may be used to create a new “clip” or snippet of one or more original versions (e.g., in the case of “music” or other audio content, ringtones may be created). In some instances, this may entail, at the CE device, receiving a network podcast using the CE device transceiver and receiving the podcast from the transceiver by the CE device processor to thus be manipulated as described above under control of the processor. Furthermore, it is to be understood that the clips that are created using a tracking clock UI as described above may thus be saved to a library of clips, shared with others, and deleted by the user as desired.

In reference to the tracking clocks themselves and in accordance with present principles, it is to be understood that in exemplary embodiments the circumference of the dial may encompass based on the N line segments shown thereon only an hour of a podcast, and that a user may thus need to manipulate dial more than one revolution to advance or rewind within the content more than one hour. In addition, note that dial manipulation to seek certain portions of the e.g. podcast may occur so that a person can seek certain portions while recording is executed.

Also in some implementations of the tracking clock UI, in addition to showing the title/name of the podcast, it may present other metadata at the top portion of the UI such as the date of the podcast, the current chapter of the podcast, and the podcast's author. Even further, any of this metadata, or alternatively the upper section as a whole that presents this metadata, may be selectable to cause a (custom, if desired) tableView screen to be presented that may list all e.g. podcasts, audiobooks, iTunes U files, voice notes, etc. available to the CE device presenting the tracking clock (e.g., stored on the CE device). The user may thus select another audio file from that screen to manipulate using a tracking clock in accordance with present principles. Furthermore, though not shown in FIGS. 4, 5, and 8, a chapter selector element may be presented on a tracking clock UI in accordance with present principles for a user to navigate and playback different chapters of a given podcast. Similarly, a home screen selector may also be presented on a tracking clock UI to cause a home screen of the CE device to be presented.

In reference to the volume sliders described above, note that a seek slider for sliding up and down to advance or rewind within a presented piece of content may also be provided to thus provide plural ways for a user to rewind or advance within the audio content using the tracking clock UI and indeed even when recording, if desired. However, note that in some embodiments both volume and seek sliders presented on a tracking clock UI may be respectively presented far on left and right portions of the tracking clock UI and may be as narrow as possible given, e.g., the CE device display size, to allow the tracking clock itself to be presented as large as possible for ease of user manipulation.

In reference to the types of audio content for manipulation to create a clip thereof, note that such content may come from a local e.g. iTunes library (local relative to the CE device) and even from cloud storage using cloud computing over a network. In fact, video podcasts may be used in accordance with present principles, even if in certain embodiments while using the tracking clock itself only the audio of the video podcast is presented for manipulation. In such cases, however, present principles recognize that the “clip” created therefrom may include the video data if desired in addition to the audio data (rather than only audio data being created from the original content), and hence when sharing via email or social networking (or simply viewing at a later time) the clip may present both the video and audio portions for the clip of audio that was created using a tracking clock in accordance with present principles. Even further, if desired, on a tracking clock UI in such instances, a thumbnail or window presenting the video may nonetheless be presented that presents portions of the video corresponding to the audio being presented.

Furthermore, although some of what is described above has been done specifically in reference to a podcast, it is to be understood that the foregoing disclosures regarding podcasts may similarly apply to other audio content such as voice notes, audio books, and music files. What's more, present principles recognize that the clips created using a tracking clock application/software as described above may themselves be “clipped” and/or re-clipped to select portions thereof in accordance with present principles so that the created clips may be shortened even further if desired.

In reference to the back buttons described above, it is to be understood that selection of such a button may in exemplary instances cause the immediately previous UI/screen to again be presented that was presented prior to presentation of the screen presenting the back button. Thus, for instance, selection of a back button from a “sub-screen” may respectively cause the UIs of any of, e.g., FIG. 8, 9, 13, 14, 18, 20, or 21 to again be presented if the “sub-screen” was presented responsive to selection of an element from one of the UIs shown in e.g., FIG. 8, 9, 13, 14, 18, 20, or 21. This is sometimes referred to as, e.g., “segment control.” Regardless, it may thus be appreciated that selection of a back button may cause a “currently” selected or subject clip library and/or list to be presented based on selection thereof depending on which “mode” or feature (e.g., type of audio content and/or clip) is currently being manipulated by a user as, e.g., sometimes indicated by the text indicators at the top of the exemplary UIs described herein.

Note that a “podcast” as described herein is exemplary embodiments understood to be, e.g., a form of content (e.g. digital media) that may be one of series of audio radio, video, PDF, or ePub files (e.g., “episodes”) that are available to a user or otherwise may be subscribed to and acquired (e.g., downloaded) through an audio content providing service such as, e.g., iTunes, a “web syndication,” or that is otherwise streamed online.

Still other features are understood by the present application though not described specifically in reference to the figures. For instance, clips that are created may be tracked e.g. using serves for targeted marketing and/or advertising. As another example, using a social networking application, friends of the user may choose to specifically follow or cause to be presented in their news feed clips that are created and posted by the user being followed. Further still, when sharing clips, links to the original source of the audio content from which the clip was created may be provided (e.g. an Amazon.com link to the audio book from which the clip was derived). Thus, it may be appreciated there are many possible ways to share clips including the sharing buttons described above (e.g., Facebook buttons), sharing one out of an archive of clips (e.g. opening up the clip from the archive to an information page pertaining to the clip and sharing it from there), and also directly after saving a clip that has been created.

Additionally, if desired the UIs of e.g. FIGS. 14, 15, 18, and 19 may include a shuffle button to right of search bar that does not necessarily (but still may) include a play symbol (denoted by a “play” triangle) and have the cross-arrows fill up the entire button. In regard to FIGS. 20 and 21, though not shown, these figures may include a sort button (e.g. to right of search bar). The text for this button may be changed so it includes the text “view” along with a vertical line to the right with arrow heads pointing up and down. Even further, note that the “library” screens described herein may include rows of alternating shades of gray (e.g. a first, lighter gray and a second, darker gray that alternate).

In regard to the feed screens described herein, they may also include an indicator (e.g. a number) of shares a clip has gotten, either by the user of the CE device presenting the feed screen or all shares and re-shares from any device and/or user that the clip has gotten. Also regarding the feed screen, it may include a portion dedicated to when the user adds/views comments such that it may show the comments, an “add comment” button, etc. E.g., a user may tap on the comment button (e.g., a bubble) in a row for a piece of content then one or more comment rows may appear under that row (e.g. and above the next row as previously displayed). The first comment row may be an “Add comment . . . ” button and subsequent rows may be comments from people, including or excluding the user in varying embodiments. Further describing the feed screens described herein, it is to be understood that they show what clips e.g. a user's friends are (e.g. currently) sharing, by date in descending order (e.g. chronologically or reverse-chronologically), with each row of info similar to an e.g. “clip library” row. A user may thus quickly see podcast content such as a show (e.g. or audiobook, or voice note), show date, clip length, etc. that each friend has recently posted. The user may thus play the posted clip, and can also see how many (e.g. other) people have made comments. There may also be a right-arrow presented on one or more of the rows that when selected causes a comment board (UI) to be presented. Accordingly, it is to be understood that such screens expand the social networking ability of present principles and the applications/software described herein, thus providing access to many of the features of a website in mobile format.

Regarding the tracking clock UIs described herein, note that in some embodiments, if desired the circular tracking clock (e.g., the “dial”) may include a color fill-in as playback and/or manipulation progresses (e.g. in a way similar to the “fill-in” of the tracking bar of FIG. 23). This “fill-in” may be presented with and without a thumb (e.g. input such that the fill-in in some embodiments is only presented when input directed to the UI is detected while in other embodiments it is presented regardless of whether input is detected).

Also note that in some embodiments, selecting a music selector such as the music selector 111 may, instead of performing the function described above in relation thereto, may automatically begin random access music playback of another piece of audio content, e.g., stored on the CE device. In such an instance, the music selector may then switch to the tracking clock UI to instead present a podcast button that may appear similar to a “snippet man logo head,” which is a proprietary widget/logo associated with the present inventor(s)/assignee. Furthermore, in such a case, selecting the podcast button may again cause presentation of the previously loaded podcast.

Further still and in reference to playing random-access music, present principles recognize that in some instances a user can stay within the currently loaded album associated with the currently loaded piece of audio content by changing an option within the settings of the tracking clock application to thus have another piece of audio content randomly presented through the tracking clock application from the same album rather than, e.g., a music library at large. For example, in main settings UI for a tracking clock application, there may be an option for “random-access by album” and one for “random-access by song.”

Even further and still in terms of a random-access music button that may be presentable on a tracking clock UI for selection by a user, the random-access music button may include music symbol (e.g., a musical note) in the “header.” Selecting such a music button while the CE device is playing a podcast may thus instantly begin random access music playback or other audio content. Subsequent to that, the music button may then be replaced at the same location of the UI on which it was presented with a Podcast button that may appear like a “snippet man logo head,” which is the proprietary logo of the inventor(s)/assignee of the present application. Selecting his Podcast button in turn may cause the previously loaded podcast to again resume playback.

Yet another feature of a tracking clock UI not specifically referenced above is a mark button that is selectable by a user. A mark button may be selected from a tracking clock UI to (e.g., automatically without further user input after selection of the mark button) save the currently playing audio content and/or created clip. Thereafter, the user may navigate to an audio content (e.g., music) library or UI such as those described above and select a new album/file of music or other audio content, which may then be loaded. After loading, the mark button when selected may cause the tracking clock software to switch back and forth between the two contents/files to thereby mimic a “last” function (it being understood that the mark button, in addition to or in lieu of including the text “mark,” may also or alternatively include the text “last”). Accordingly, selecting the mark/last button may instantly resume play of the previous audio file.

Last, note that present principles recognize that the tracking clock UIs and tracking clock software/applications disclosed herein may be used as a “ringtone” app in that ringtones may be created from audio content in accordance with present principles and then these ringtone snippets may be uploaded to a mobile phone or otherwise used as a ring tone for a phone.

While the particular NAVIGATING AUDIO CONTENT AND SELECTING PORTIONS THEREOF USING CIRCULAR DIAL ON USER INTERFACE is herein shown and described in detail, it is to be understood that the subject matter which is encompassed by the present invention is limited only by the claims.

What is claimed is:

1. A consumer electronics (CE) device comprising:
a transceiver configured for receiving a network podcast;
a processor configured for receiving podcast data from the transceiver;
a display configured for being controlled by the processor; and
a computer readable storage medium bearing instructions which when executed by the processor configure the processor for:
presenting on the display a podcast user interface (UI) configured with a circular tracking clock for enabling a user of the CE device to access a beginning of any portion of a segment of the podcast easily and quickly to playback the podcast from the beginning of the portion, the tracking clock defining a closed circular periphery against which a user can move a finger to move forward and backward in time through the podcast.

2. The CE device of claim 1, wherein the UI is further configured with a red record button in middle of the tracking clock.

3. The CE device of claim 2, wherein the record button pulses to indicate recording.

4. The CE device of claim 1, wherein the UI is further configured with a vertical slide on one side of the tracking clock.

5. The CE device of claim 1, wherein the tracking clock includes plural segment lines radially oriented.

6. The CE device of claim 5, wherein at least every Nth segment line appears more prominently than adjacent segment lines.

7. The CE device of claim 1, wherein a current location of play of the podcast is indicated by a marker line that rotates around the tracking clock as the podcast plays.

8. The CE device of claim 1, wherein the tracking clock is a hollow ring with an inner circular edge spaced from and coaxial to an outer circular edge.

9. A method, comprising:
presenting a user interface (UI) on a display of a display device, the UI including a circular dial for enabling a user of the display device to manipulate, at least partially by manipulating the dial, at least a portion of audio content presented on the display device, the dial defining a closed circular periphery against which the user can move a finger to move forward and backward within the audio content;
receiving user input by manipulating the dial to manipulate the portion of audio content.

10. The method of claim 9, wherein the user input is directed to a user-manipulable indicator presented on the dial relatively more prominently than other portions of the dial not including the indicator, the indicator rotating around the dial at least based on user input.

11. The method of claim 10, wherein manipulation of the indicator in the clockwise direction fast-forwards the audio content and manipulation of the indicator in the counter clockwise direction rewinds the audio content.

12. The method of claim 9, wherein the UI is further configured with a record button in middle of the dial, the record button being selectable by the user to begin a recording of a segment of the audio content, at least the beginning of the segment being established based on user manipulation of the dial.

13. The method of claim 12, wherein the record button pulses to indicate recording is being executed.

14. The method of claim 13, wherein selection of the record button when pulsing causes the recording of the segment to cease and further causes a save window to be overlaid on at least a portion of the UI, the save window being manipulable to save at least the segment.

15. The method of claim 14, wherein the save window includes at least one selector element which when selected causes the segment to be automatically posted to at least one social networking service.

16. The method of claim 11, wherein the UI is further configured with at least one selector element outside the closed circular periphery that is manipulable to fast-forward or rewind within the audio content a predetermined amount of time.

17. The method of claim 9, wherein the UI is further configured with a vertical slider on one side of the dial to adjust the volume of the audio presented on the display device.

18. A computer readable storage medium that is not a carrier wave and bearing instructions which when executed by a processor cause the processor to:
receive input directed to a user interface (UI), the UI including a dial defining a closed circular periphery around which a user can move a finger to move forward and backward within a first audio content when creating at least a second audio content at least partially from a selected portion of the first audio content;
edit the first audio content based on the user input that is received using the dial to establish the selected portion.

19. The computer readable storage medium of claim 18, wherein the UI is further manipulable to create the second audio content from the selected portion.

20. The computer readable storage medium of claim 18, wherein the first audio content is a voice note.
